(19) United States
(12) Patent Application Publication
(10) Pub. No.: US 2015/0086184 A1
(43) Pub. Date: Mar. 26, 2015

(54) RECEPTION APPARATUS AND RECEPTION METHOD

(71) Applicant: FUJITSU LIMITED, Kawasaki-shi (JP)

(72) Inventor: Akira TAKAMUNE, Kawasaki (JP)

(21) Appl. No.: 14/465,544

(22) Filed: Aug. 21, 2014

(30) Foreign Application Priority Data
Sep. 25, 2013 (JP) 2013-198483

(51) Int. Cl. H04N 21/44; H04N 21/458; H04N 21/43; H04N 21/432; H04N 21/414

(52) U.S. Cl. CPC H04N 21/44016; H04N 21/4325; H04N 21/41407; H04N 21/4307; H04N 21/458
USPC 386/353

(57) ABSTRACT

A reception apparatus includes a wireless communication circuit configured to receive video content through wireless communication, a memory; and a processor coupled to the memory, configured to play back the video content, make a first determination as to whether or not sequential playback of first video content having a first image quality, the sequential playback being performed in parallel with reception of the first video content, is continuable, and control, when the processor determines in the first determination that the sequential playback of the first video content is not continuable during sequentially playing back the first video content, switching processing for switching the video content to be played back from the received first video content to second video content stored in the memory, the second video content having a second image quality lower than the first image quality and having the same contents as contents of the first video content.

### CROSS-REFERENCE TO RELATED APPLICATION

This application is based upon and claims the benefit of priority of the prior Japanese Patent Application No. 2013-198483 filed on Sep. 25, 2013, the entire contents of which are incorporated herein by reference.

### FIELD

The embodiments discussed herein are related to a reception apparatus and a reception method.

### BACKGROUND

There is proposed a reception apparatus that receives video content through wireless communication and performs sequential playback (also called streaming playback) on the received video content. With the increasing wireless communication speed today, such a reception apparatus utilizes the increased-speed wireless communication to receive high-image-quality video content having a large data size and performs sequential playback on the received high-image-quality video content. Such a technology is disclosed in, for example, Japanese National Publication of International Patent Application No. 2006-523417 and Japanese Laid-open Patent Publication No. 2012-39221.

### SUMMARY

According to an aspect of the invention, a reception apparatus includes a wireless communication circuit configured to receive video content through wireless communication, a memory; and a processor coupled to the memory, configured to play back the video content, make a first determination as to whether or not sequential playback of first video content having a first image quality, the sequential playback being performed in parallel with reception of the first video content, is continuable, and control, when the processor determines in the first determination that the sequential playback of the first video content is not continuable during sequentially playing back the first video content, switching processing for switching the video content to be played back from the received first video content to second video content stored in the memory, the second video content having a second image quality lower than the first image quality and having the same contents as contents of the first video content.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a delivery system to which a reception apparatus according to an embodiment is applied;

FIG. 2 is a block diagram illustrating an example of the hardware configuration of a reception apparatus;

FIG. 3 is a block diagram illustrating an example of the software configuration of the reception apparatus;

FIG. 4 is a block diagram illustrating an example of the hardware configuration of a delivery apparatus;

FIG. 5 is a block diagram illustrating an example of the software configuration of the delivery apparatus;

FIG. 6 is a sequence diagram illustrating an example of first switching processing for switching video content played back from high-image-quality video content to low-image-quality video content;

FIGS. 7A and 7B are time charts illustrating examples of second switching processing for switching from high-image-quality video content to low-image-quality video content;

FIG. 8 is a sequence diagram illustrating an example of the second switching processing for switching video content to be played back from high-image-quality video content to low-image-quality video content while sequentially playing back the audio portion (high sound quality) of the high-image-quality video content;

FIG. 9 is a sequence diagram illustrating an example of processing for switching video content to be played back from low-image-quality video content to high-image-quality video content;

FIG. 10 is a first flowchart illustrating a flow of switching processing for switching from high-image-quality video content to low-image-quality video content, the switching processing being performed by the reception apparatus;

FIG. 11 is a second flowchart illustrating the flow of the switching processing for switching from the high-image-quality video content to the low-image-quality video content, the switching processing being performed by the reception apparatus;

FIG. 12 is a sequence diagram illustrating first storage processing for low-image-quality video content;

FIG. 13 is a sequence diagram illustrating an example of second storage processing for low-image-quality video content;

FIG. 14 is a first flowchart illustrating a flow of the second storage processing for low-image-quality video content; and

FIG. 15 is a second flowchart illustrating the flow of the second storage processing for the low-image-quality video content.

### DESCRIPTION OF EMBODIMENTS

When the reception apparatus sequentially plays back video content, the quality of wireless communication decreases in some cases. In such a case, when the video content is a moving image, the reception apparatus may not be able to receive some of multiple continuous video frames in the video content. Consequently, during the sequential playback of the video content, the so-called frame dropout occurs, thereby making it difficult for the viewer to comfortably view and listen to the video content.

As a result of a decrease in the quality of wireless communication, there are also cases in which the reception apparatus is not able to receive every video frame of the video frames in a certain period. Consequently, in that certain period, the reception apparatus is not able to perform sequential playback of the video content, and thus the viewer is not able to view and listen to the video content. Similarly, when the reception apparatus moves out of the communication area of a base station with which it performs wireless communication, and becomes unable to perform wireless communication, the viewer is not also able to view and listen to the video content.

As described above, when the quality of wireless communication decreases or when it is difficult to continue wireless communication, the video content is not played back while maintaining the continuity of the video playback.

One aspect of the present embodiment is to play back video content even when the quality of wireless communication decreases or when it is difficult to perform wireless communication.

### First Embodiment

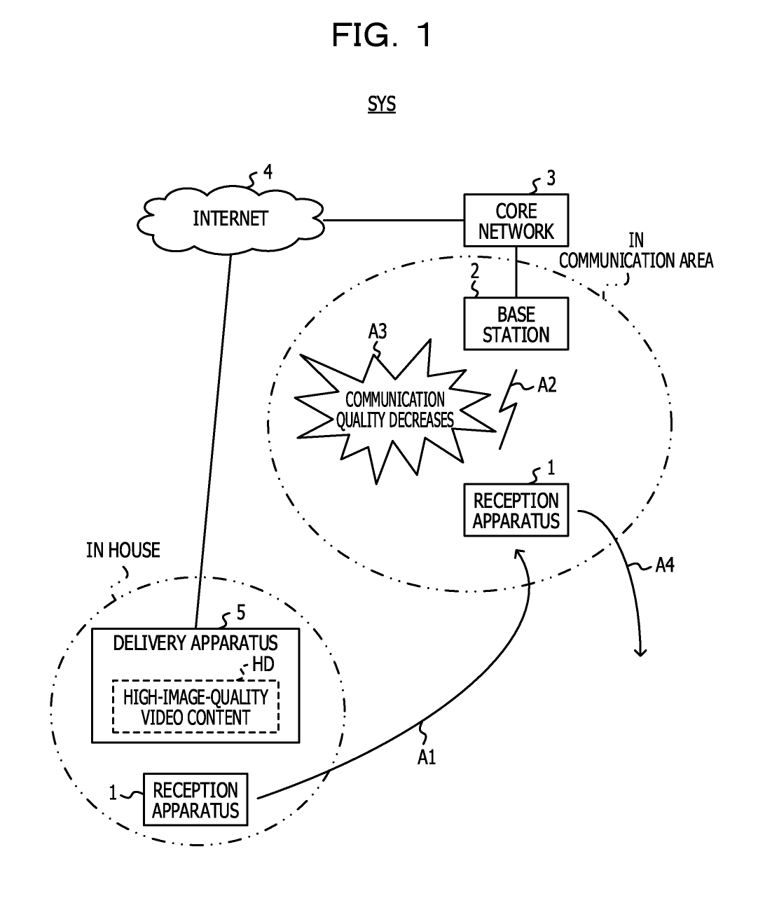

A delivery system to which a reception apparatus according to the present embodiment is applied will be described below with reference to FIG. 1. In the following description, substantially the same elements are denoted by the same reference numerals, as appropriate, and redundant descriptions are not given.

(Delivery System)

FIG. 1 is a diagram illustrating an example of a delivery system to which a reception apparatus according to the present embodiment is applied. A delivery system SYS includes a reception apparatus 1, a base station 2, a core network 3, an Internet 4, and a delivery apparatus 5. In recent years, by using the reception apparatus 1 at places outside the home, a user of the reception apparatus 1 can view and listen to various types of video content of a television program, a movie, an artist-performance video, and so on recorded on a video recording device. The delivery apparatus 5 stores the video content, and delivers the video content to the reception apparatus 1 in response to a request from the reception apparatus 1.

The reception apparatus 1 is, for example, a portable apparatus (also called a “mobile apparatus”), such as a mobile phone, a tablet computer, a smartphone, and a vehicle-mounted apparatus.

The reception apparatus 1 wirelessly communicates with the base station 2, and also communicates with the delivery apparatus 5 through the base station 2, the core network 3, and the Internet 4.

The reception apparatus 1 receives the video content, delivered by the delivery apparatus 5, through a communication path passing through the base station 2, the core network 3, and the Internet 4, which are located between the reception apparatus 1 and the delivery apparatus 5, and sequentially plays back the received video content. This sequential playback is also called streaming playback, which is processing for sequentially playing back, without waiting for completion of receiving all data of a piece of video content, received video data in parallel with the reception of the video data.

The base station 2 wirelessly communicates with the reception apparatus 1 and communicates with the core network 3 in a wired manner. For example, a Long Term Evolution (LTE) wireless communication system or a third generation (3G) wireless communication system is used for the wireless communication between the base station 2 and the reception apparatus 1. The core network 3 is a network that relays a communication between the base station 2 and the Internet 4. The core network 3 is also called a backbone network. The Internet 4 is a large-scale computer network.

The delivery apparatus 5 serves as, for example, a HyperText Transfer Protocol (HTTP) server or a network-attached storage (NAS) and connects to the Internet 4 via a communication apparatus (not illustrated) provided by an internet service provider.

The delivery apparatus 5 stores data of various types of content, such as video content (for example, high-image-quality video content HD). In response to a delivery request from the reception apparatus 1, the delivery apparatus 5 delivers (transmits) the data of content corresponding to the delivery request to the reception apparatus 1. The delivery apparatus 5 is provided, for example, in a house (see an area circled by a dashed-dotted line) of a general household.

(Use Form of Reception Apparatus)

Next, a use form of the reception apparatus 1 will be described with reference to FIG. 1. A user of the reception apparatus 1 (hereinafter simply referred to as a “user”, as appropriate) takes the reception apparatus 1 out of the house (see reference character A1) and moves into the communication area of the base station 2 (see a circle surrounded by a long dashed double-short dashed line). The reception apparatus 1 then wirelessly communicates with the base station 2 to establish a connection with the delivery apparatus 5 (see reference character A2). The user then operates the reception apparatus 1 to give, to the delivery apparatus 5, a delivery request for delivering video content having a first image quality. The expression “video content having a first image quality” is, for example, high-image-quality video content HD. The first image quality is hereinafter referred to as a “high image quality”, as appropriate.

In response to the delivery request, the delivery apparatus 5 delivers high-image-quality video content HD to the reception apparatus 1. The reception apparatus 1 receives the high-image-quality video content HD delivered from the delivery apparatus 5 and sequentially plays back the received high-image-quality video content HD.

Now, assume a first case (see reference character A3) in which the quality of wireless communication with the base station 2 decreases and a second case (see reference character A4) in which the user who carries the reception apparatus 1 moves out of the communication area of the base station 2.

In the first case, the reception apparatus 1 may not be able to receive some of continuous video frames. Consequently, during the sequential playback of the video content, the so-called frame dropout occurs to thereby make it difficult for the viewer to comfortably view/listen to the video content. In the first case, the reception apparatus 1 may not be able to receive all of the video frames in a certain period.

In the second case, the reception apparatus 1 is not able to receive the video content while it is located outside the communication area of the base station 2, and in this period, no sequential playback of the video content is possible. Consequently, the viewer is not able to view/listen to the video content.

Accordingly, even when the quality of wireless communication decreases or it is difficult to perform wireless communication, the reception apparatus 1 plays back the video content.

(Configurations of Reception Apparatus and Delivery Apparatus)

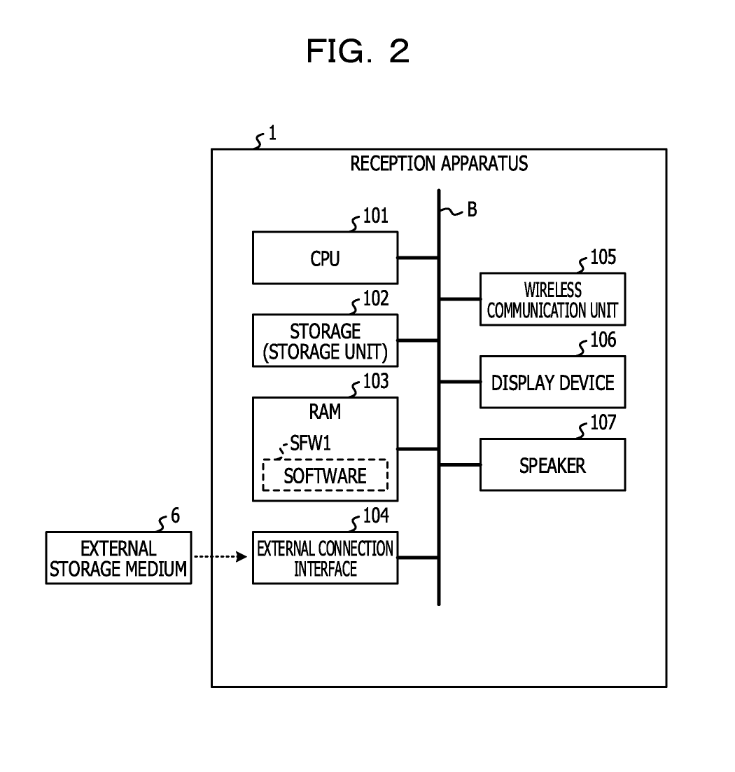

The hardware configurations and the software configurations of the reception apparatus 1 and the delivery apparatus 5 will be described below with reference to FIGS. 2 to 5.

(Hardware Configuration of Reception Apparatus)

FIG. 2 is a block diagram illustrating an example of the hardware configuration of the reception apparatus 1. The reception apparatus 1 includes a central processing unit (CPU) 101, a storage (storage unit) 102, a random access memory (RAM) 103, and an external connection interface 104, which are connected through a bus B. The storage (storage unit) 102 will hereinafter be referred to as a “storage 102”, as appropriate. The reception apparatus 1 further includes a wireless communication unit 105, a display device 106, and a speaker 107, which are connected through the bus B.

The CPU 101 is an arithmetic processing device that controls the entire reception apparatus 1. The storage 102 is, for example, a mass storage device, such as a hard-disk drive (HDD), a solid-state drive (SSD), or the like.

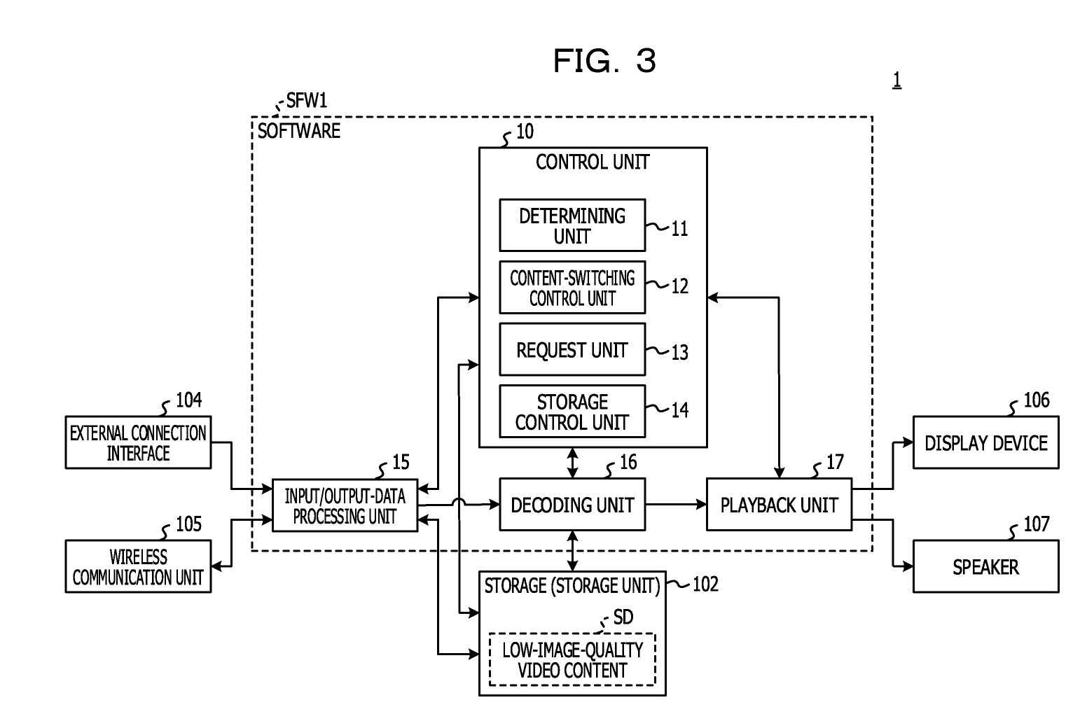

The RAM 103 temporarily stores software SFW1 and data processed in various types of information processing executed by the CPU 101. The RAM 103 is, for example, a semiconductor memory, such as a dynamic random access memory (DRAM). The software SFW1 is described later in detail with reference to FIG. 3.

The external connection interface 104 is a device that serves as an interface for connecting the reception apparatus 1 with an external apparatus and an external storage medium 6. The external connection interface 104 is, for example, a card slot or a Universal Serial Bus (USB) port. The external apparatus is, for example, the delivery apparatus 5.

The external storage medium 6 is a portable nonvolatile memory, such as a USB memory. The reception apparatus 1 may also be configured to connect to a storage-medium reading device (not illustrated) for reading data, stored in a storage medium, via the external connection interface 104. The storage medium (also called a “recording medium”) is, for example, a portable storage medium, such as a compact disc read-only memory (CD-ROM) or a digital versatile disc (DVD).

The wireless communication unit 105 performs wireless communication with the base station 2 to receive the video content via the wireless communication. More specifically, the wireless communication unit 105 receives, via an antenna (not illustrated), transmission signals transmitted from the base station 2 and demodulates and decodes the received signals to generate decoded signals. The wireless communication unit 105 also encodes and modulates request signals for requesting the delivery apparatus 5 to perform various types of processing and transmits the modulated signals to the base station 2 via the antenna (not illustrated).

The display device 106 is a liquid-crystal display or an organic electroluminescent (EL) display and displays and outputs the video data of video content. The display device 106 has a touch panel for inputting operational information of an operator of the reception apparatus 1 and also serves as an input device.

The speaker 107 is a device for outputting sound of audio data of video content. The reception apparatus 1 may also be configured to have a jack for a headphone or an earphone, together with the speaker 107.

(Software Configuration of Reception Apparatus)

FIG. 3 is a block diagram illustrating an example of the software configuration of the reception apparatus 1. The software SFW1 includes a control unit 10, a determining unit 11, a content-switching control unit 12, a request unit 13, a storage control unit 14, an input/output-data processing unit 15, a decoding unit 16, and a playback unit 17. In FIG. 3, the storage 102 stores therein low-image-quality video content SD, which is described below. The storage 102 is an example of a storage unit that stores low-image-quality video content SD.

A program for executing the software SFW1 is stored in, for example, the storage 102. During startup of the reception apparatus 1, the CPU 101 illustrated in FIG. 2 reads the execution program stored in the storage 102, and loads the execution program into, for example, the RAM 103 illustrated in FIG. 2, and causes the read program to function as the software SFW1. The execution program may also be stored in the external storage medium 6 described above with reference to FIG. 2. In this case, the CPU 101 illustrated in FIG. 2 reads the execution program from the external storage medium 6.

The control unit 10 executes various types of control processing and also controls the determining unit 11, the content-switching control unit 12, the request unit 13, the storage control unit 14, the input/output-data processing unit 15, the decoding unit 16, and the playback unit 17.

The determining unit 11 makes a first determination as to whether or not sequential playback of first video content having a first image quality, the sequential playback being performed by the playback unit 17 in parallel with reception of the first video content, is continuable. The video content having the first image quality is high-image-quality video content HD, as described above with reference to FIG. 1.

When it is determined in the first determination that the sequential playback is not continuable while the playback unit 17 sequentially plays back the first video content, the content-switching control unit 12 executes the following processing. That is, the content-switching control unit 12 controls switching processing for switching the video content to be played back by the playback unit 17 from the received first video content to second video content stored in the storage unit, the second video content having a second image quality lower than the first image quality and having the same contents as the contents of the first video content.

The storage unit is, for example, the storage 102. The second video content having the second image quality is low-image-quality video content SD. After the description of the blocks in FIG. 3 is completed, the low-image-quality video content and the high-image-quality video content will be described in detail.

The request unit 13 generates request signals for requesting the delivery apparatus 5 to perform various types of processing. The storage control unit 14 controls processing for storing the low-image-quality video content SD in the storage 102.

The input/output-data processing unit 15 extracts, from decoded signals output by the wireless communication unit 105, video data and audio data used for playback of video content and outputs the extracted video data and audio data to the decoding unit 16. The input/output-data processing unit 15 outputs, to the wireless communication unit 105, the request signals (request data) output by the control unit 10 to request the delivery apparatus 5 to perform various types of processing.

The decoding unit 16 decodes the input data. More specifically, the decoding unit 16 decodes data encrypted and output by the input/output-data processing unit 15. When the decoded data is compressed data, the decoding unit 16 decompresses the decoded data. The decoding unit 16 outputs the video data and audio data of the decompressed data to the playback unit 17 or the storage 102.

The playback unit 17 plays back the video content. More specifically, the playback unit 17 displays, on the display device 106, video based on the video data output by the decoding unit 16. The playback unit 17 outputs, from the speaker 107, sound based on the audio data output by the decoding unit 16.

The functions of the blocks, for example, the functions of the decoding unit 16 and the playback unit 17, illustrated in FIG. 3 may also be realized by hardware.

(Operation of Determining Unit 11)

Next, a description will be given of the operation of the determining unit 11. After sequential playback of the high-image-quality video content HD is started, the determining unit 11 determines, for example, at each predetermined timing, whether or not the sequential playback of the high-image-quality video content HD is continuable.

During the sequential playback of the high-image-quality video content HD, for example, when the reception apparatus 1 moves out of the communication area of the base station 2 (see reference numeral A4 in FIG. 1), the determining unit 11 determines that the sequential playback of the high-image-quality video content HD is not continuable. Also, when the quality of wireless communication with the base station 2 decreases (see reference numeral A3 in FIG. 1), the determining unit 11 determines that the sequential playback of the high-image-quality video content HD is not continuable.

The determining unit 11 determines that the sequential playback of the high-image-quality video content HD is not continuable (hereinafter referred to as “video sequential playback is not possible”, as appropriate), for example, by using any of the following six determination schemes.

The first determination scheme is a scheme for determining whether or not the frame rate of video frames played back by the playback unit 17 is lower than a pre-defined first reference frame rate. The playback unit 17 determines the frame rate of video frames played back and outputs the frame rate to the determining unit 11. When the frame rate determined by the playback unit 17 is lower than the first reference frame rate, the determining unit 11 determines that the video sequential playback is not possible. The first reference frame rate is a rate pre-defined by a developer of the reception apparatus 1 through an experiment or the like.

A second determination scheme is a scheme for determining whether or not a wireless error rate in wireless communication is higher than or equal to a pre-defined first reference wireless error rate. The input/output-data processing unit 15 measures an amount of information that is correctly demodulated by the wireless communication unit 105 and an amount of information that is not correctly demodulated thereby, determines a wireless error rate, and outputs the wireless error rate to the determining unit 11. When the wireless error rate determined by the input/output-data processing unit 15 is higher than or equal to the first reference wireless error rate, the determining unit 11 determines that the video sequential playback is not possible. The first reference wireless error rate is a wireless error rate pre-defined by the developer of the reception apparatus 1 through an experiment or the like.

A third determination scheme is a scheme for determining whether or not a pre-defined amount of video data used for sequential playback is received within a first reference time. The input/output-data processing unit 15 determines an amount of data of video data of video content received by the wireless communication unit 105 within the first reference time, and outputs the amount of data to the determining unit 11. When the amount of data determined by the input/output-data processing unit 15 is smaller than the amount of video data used for sequential playback, the determining unit 11 determines that the video sequential playback is not possible. The amount of video data used for sequential playback and the first reference time are pre-determined by the developer of the reception apparatus 1 through an experiment or the like.

A fourth determination scheme is a scheme for determining whether or not a radio-wave strength in wireless communication with the base station 2, the radio-wave strength being measured by the wireless communication unit 105, is smaller than a first reference radio-wave strength. When the radio-wave strength measured by the wireless communication unit 105 is smaller than the first reference radio-wave strength, the determining unit 11 determines that the video sequential playback is not possible. The first reference radio-wave strength is a radio-wave strength pre-defined by the developer of the reception apparatus 1 through an experiment or the like.

A fifth determination scheme is a scheme for determining whether or not the loss rate of communication packets contained in transmission signals transmitted from the base station 2 to the reception apparatus 1 in wireless communication between the base station 2 and the reception apparatus 1 is higher than or equal to a first reference loss rate. The wireless communication unit 105 or the input/output-data processing unit 15 determines the loss rate of communication packets and outputs the loss rate to the determining unit 11.

When the loss rate determined by the wireless communication unit 105 or the input/output-data processing unit 15 is higher than the first reference loss rate, the determining unit 11 determines that the video sequential playback is not possible. The first reference loss rate is a loss rate pre-defined by the developer of the reception apparatus 1 through an experiment or the like.

A sixth determination scheme is a scheme for determining whether or not an elapsed time from when the control unit 10 issues an “HTTP GET” request to the delivery apparatus 5 until the control unit 10 receives, from the delivery apparatus 5, a response to the “HTTP GET” request exceeds a first time. When the elapsed time exceeds the first time, the determining unit 11 determines that the video sequential playback is not possible. The first time is pre-determined by the developer of the reception apparatus 1 through an experiment or the like.

(Operation of Content-Switching Control Unit 12)

Next, a description will be given of the content-switching control unit 12. While the playback unit 17 sequentially plays back high-image-quality video content HD, when the determining unit 11 determines that the sequential playback is not continuable, the content-switching control unit 12 executes the following processing. That is, the content-switching control unit 12 controls switching processing for switching the video content to be played back by the playback unit 17 from received high-image-quality video content HD to low-image-quality video content SD stored in, for example, the storage 102.

A description will be given of the resolution and the bit rate of the high-image-quality video content HD. It is assumed that the high-image-quality video content HD is, for example, video content having one of the following three resolutions. A first resolution has a width of 1920 pixels and a height of 1080 pixels. A second resolution has a width of 1440 pixels and a height of 1080 pixels. A third resolution has a width of 1280 pixels and a height of 780 pixels. Video content having any of the first to third resolutions is also referred to as high definition (HD) image quality video content. The bit rate of the high-image-quality video content HD is, for example, 2 to 24 Mbps.

A description will be given of the resolution and the bit rate of the low-image-quality video content SD. It is assumed that the low-image-quality video content SD is, for example, video content having one of the following three resolutions. A first resolution has a width of 720 pixels and a height of 480 pixels. A second resolution has a width of 640 pixels and a height of 480 pixels. Video content having the first or second resolution is referred to as standard definition (SD) image quality video content. A third resolution has a width of 640 pixels and a height of 360 pixels. The bit rate of the low-image-quality video content SD is, for example, 1.5 to 2.4 Mbps.

The high-image-quality video content HD and the low-image-quality video content SD are different from each other in the resolution and the bit rate, and are the same in the contents of the video content. For example, when the video content is a movie or a news program, the high-image-quality video content HD and the low-image-quality video content SD have the same contents, and are the same movie or the same news program.

(Hardware Configuration of Delivery Apparatus)

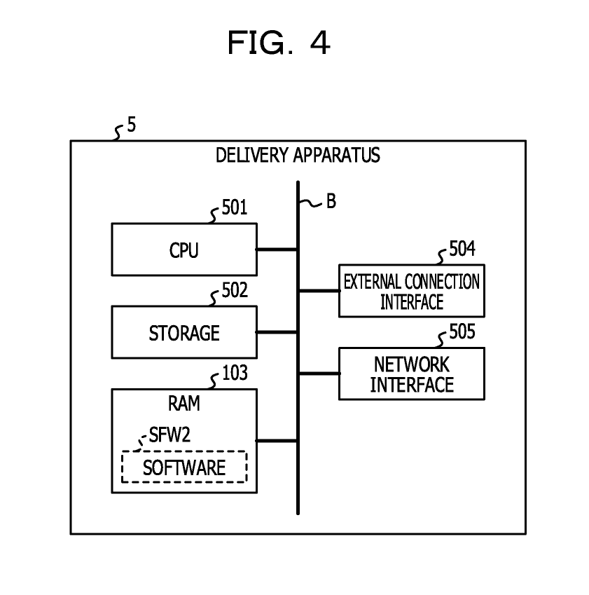

FIG. 4 is a block diagram illustrating an example of the hardware configuration of the delivery apparatus 5. The delivery apparatus 5 includes a CPU 501, a storage 502, a RAM 503, an external connection interface 504, and a network interface 505, which are connected through a bus B.

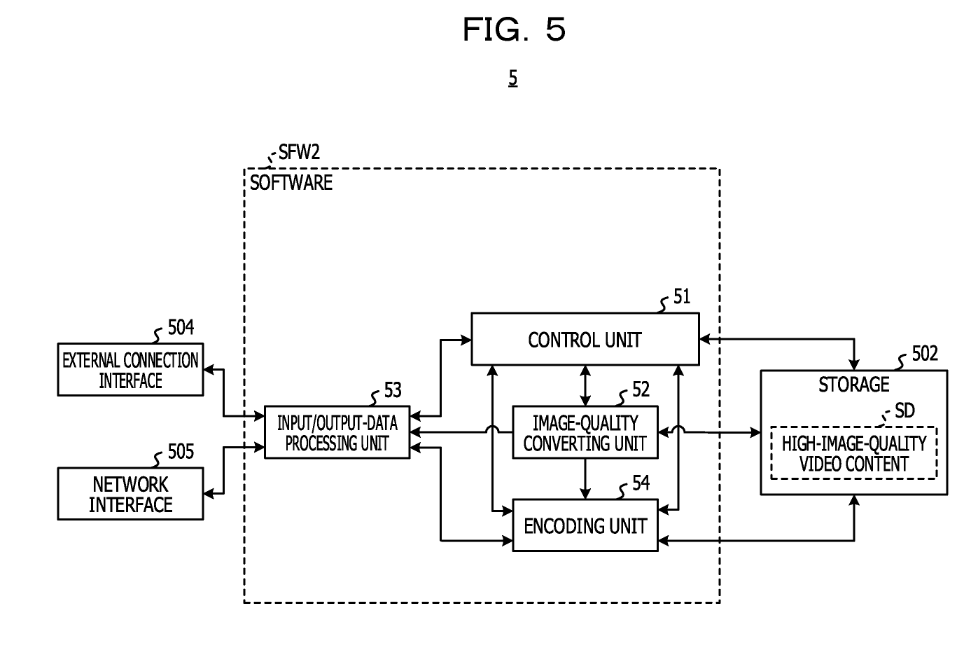

The CPU 501 is an arithmetic processing device that controls the entire delivery apparatus 5. The storage 502 is, for example, a mass storage device, such as a hard-disk drive or a solid-state drive. The storage 502 stores high-image-quality video content HD, as illustrated in FIG. 5. The RAM 503 temporarily stores software SFW2 and data processed in various types of information processing executed by the CPU 501. The RAM 503 is, for example, a semiconductor memory, such as a DRAM.

The external connection interface 504 is a device that serves as an interface for connecting the delivery apparatus 5 with an external apparatus or an external storage medium. The external connection interface 504 is, for example, a card slot or a USB port. The external apparatus is, for example, the reception apparatus 1. The external storage medium is, for example, a portable nonvolatile memory. The reception apparatus 1 may also be configured to connect to a storage-medium reading device (not illustrated) for reading data, stored in a storage medium, via the external connection interface 504. The storage medium is, for example, a portable storage medium, such as a CD-ROM or DVD.

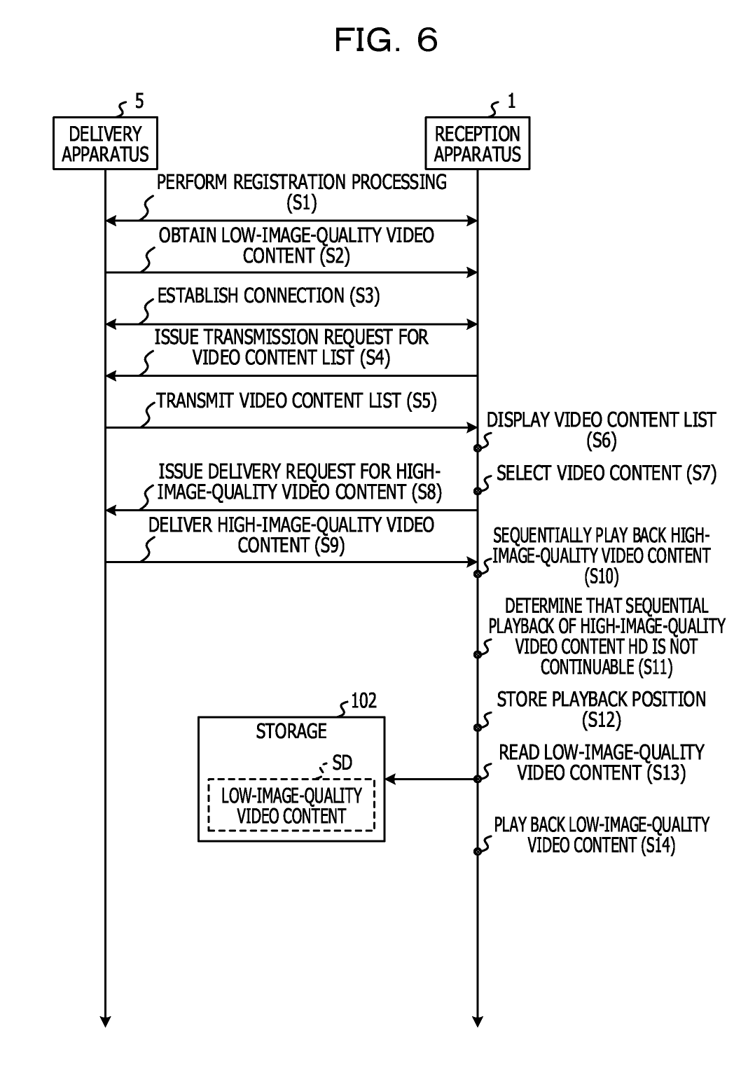

The network interface 505 is a device that serves as an interface for connection with a network, such as the Internet 4. The network interface 505 may also have, for example, a wireless communication function for directly connecting the reception apparatus 1 and the delivery apparatus 5 in registration processing (described below with reference to FIG. 6) of the reception apparatus

(Software Configuration of Delivery Apparatus)

FIG. 5 is a block diagram illustrating an example of the software configuration of the delivery apparatus 5. The software SFW2 has a control unit 51, an image-quality converting unit 52, an input/output-data processing unit 53, and an encoding unit 54.

An execution program for the software SFW2 is stored in, for example, the storage 502. During startup of the delivery apparatus 5, the CPU 501 illustrated in FIG. 4 reads the execution program stored in the storage 502, loads the read execution program into, for example, the RAM 503 illustrated in FIG. 4, and causes the read program to function as the software SFW2. The execution program may be stored in an external storage medium (not illustrated). In this case, the CPU 501 illustrated in FIG. 4 reads the execution program from the external storage medium.

The control unit 51 executes various types of control processing and also controls the image-quality converting unit 52, the input/output-data processing unit 53, and the encoding unit 54.

The image-quality converting unit 52 converts the image quality of high-image-quality video content HD stored in the storage 502 to generate low-image-quality video content SD from the high-image-quality video content HD. For example, the image-quality converting unit 52 converts the resolution of high-image-quality video content HD into the resolution of low-image-quality video content SD, and converts the bit rate of high-image-quality video content HD into the bit rate of low-image-quality video content SD. Through the resolution conversion and the bit rate conversion, the image-quality converting unit 52 generates the low-image-quality video content SD from the high-image-quality video content HD. The image-quality converting unit 52 outputs the generated low-image-quality video content SD to the input/output-data processing unit 53 or the encoding unit 54.

The input/output-data processing unit 53 stores, in the external storage medium connected to the delivery apparatus 5 via the external connection interface 504 illustrated in FIG. 4, the low-image-quality video content SD input from the image-quality converting unit 52.

The encoding unit 54 encodes the input data. More specifically, the encoding unit 54 compresses the high-image-quality video content HD read from the storage 502, encrypts the compressed high-image-quality video content HD, and outputs the encrypted high-image-quality video content HD to the input/output-data processing unit 53. The encoding unit 54 also compresses the low-image-quality video content SD input from the image-quality converting unit 52, encrypts the compressed low-image-quality video content SD, and outputs the encrypted low-image-quality video content SD to the input/output-data processing unit 53.

The input/output-data processing unit 53 further packetizes the data input from the encoding unit 54 and transmits the packetized data to the Internet 4 (see FIG. 1) via the network interface 505. More specifically, the input/output-data processing unit 53 packetizes the low-image-quality video content SD or the high-image-quality video content HD input from the encoding unit 54 and transmits the packetized video content to the Internet 4 via the network interface 505. The video content packetized and transmitted to the Internet 4 is delivered to the reception apparatus 1 through the Internet 4, the core network 3, and the base station 2, as illustrated in FIG. 1.

The input/output-data processing unit 53 also outputs, to the control unit 51, request signals transmitted from the reception apparatus 1 and received by the network interface 505.

The functions of, for example, the image-quality converting unit 52 and the encoding unit 54 illustrated in FIG. 5 may also be realized by hardware.

(First Switching Processing for Switching from High-Image-Quality Video Content HD to Low-Image-Quality Video Content SD)

FIG. 6 is a sequence diagram illustrating an example of the first switching processing for switching video content played back from high-image-quality video content HD to low-image-quality video content SD. In the following description for the sequence diagram, communications between the reception apparatus 1 and the delivery apparatus 5 are indicated by left and right arrows in the diagram. The passage of time is indicated by arrows from top to bottom in the diagram.

Processes in steps S1 to S10 are processes until the reception apparatus 1 sequentially plays back high-image-quality video content HD.

In step S1, the reception apparatus 1 in FIG. 3 requests the delivery apparatus 5 in FIG. 5 to register the reception apparatus 1. In this registration, the user uses the reception apparatus 1 in the home (see FIG. 1) where the delivery apparatus 5 is placed. The wireless communication unit 105 in the reception apparatus 1 and the network interface 505 in the delivery apparatus 5, for example, directly connect to each other through wireless communication.

The request unit 13 in the reception apparatus 1 in FIG. 3 issues a registration request to the delivery apparatus 5 in FIG. 5. In response to the registration request, the control unit 51 in the delivery apparatus 5 in FIG. 5 stores, for example, an identifier for uniquely identifying the reception apparatus 1 in the storage 502 to thereby register the reception apparatus 1. As a result of the registration, the delivery apparatus 5 brings the reception apparatus 1 under the control thereof. After the registration, it is possible to perform communication between the reception apparatus 1 and the delivery apparatus 5 through the base station 2, the core network 3, and the Internet 4 illustrated in FIG. 1. In the above-described registration of the reception apparatus 1, the external connection interface 104 in the reception apparatus 1 and the external connection interface 504 in the delivery apparatus 5 may directly connect to each other through, for example, wired communication using a USB cable.

In step S2, the reception apparatus 1 obtains, from the delivery apparatus 5, low-image-quality video content SD corresponding to the high-image-quality video content HD. The high-image-quality video content HD is video content that the user wishes to view and listen to while away from the home. That is, the high-image-quality video content HD is video content to be subjected to sequential playback described below in step S9 and steps subsequent thereto. The low-image-quality video content SD may be obtained using various schemes. For example, there are following two schemes.

A first scheme will now be described. In the first scheme, the user uses the reception apparatus 1 in the home (see FIG. 1) where the delivery apparatus 5 is placed. The user connects (inserts) the external storage medium 6, described above with reference to FIG. 2, to (into) the external connection interface 504 in the delivery apparatus 5. It is assumed in this case that the external storage medium 6 is, for example, a card memory, and the external connection interface 504 is, for example, a slot for the card memory.

The user operates operation equipment (not illustrated) of the delivery apparatus 5 in FIG. 5 to instruct the control unit 51 so as to store low-image-quality video content SD in the external storage medium 6. In response to the instruction, the control unit 51 issues an instruction to the image-quality converting unit 52 so as to generate the low-image-quality video content SD from high-image-quality video content HD.

In response to the instruction, the image-quality converting unit 52 reads the high-image-quality video content HD from the storage 502 and generates the low-image-quality video content SD having a reduced image quality. For the reduced image quality, the image-quality converting unit 52 reduces the resolution and the bit rate. Upon completing the generation of the low-image-quality video content SD, the image-quality converting unit 52 outputs the generated low-image-quality video content SD to the encoding unit 54. The encoding unit 54 encodes (compresses or encrypts) the low-image-quality video content SD input from the image-quality converting unit 52 and outputs the resulting low-image-quality video content SD to the input/output-data processing unit 53.

The input/output-data processing unit 53 stores the low-image-quality video content SD, encoded by and input from the encoding unit 54, in the external storage medium 6 (not illustrated in FIG. 5), connected to the external connection interface 504.

The user removes the external storage medium 6 in which the low-image-quality video content SD is stored from the external connection interface 504 in the delivery apparatus 5 and connects (inserts) the external storage medium 6 to the external connection interface 104 in the reception apparatus 1 in FIG. 3. The external connection interface 104 is, for example, a slot for a card memory.

By operating the touch panel or the like of the reception apparatus 1, the user issues an instruction to the control unit 10 so as to store, in the storage 102, the low-image-quality video content SD stored in the external storage medium 6. In response to the instruction, the storage control unit 14 in the control unit 10 issues an instruction to the input/output-data processing unit 15 so as to store the low-image-quality video content SD in the storage 102. In response to the instruction, the input/output-data processing unit 15 reads the low-image-quality video content SD stored in the external storage medium 6 and stores the read low-image-quality video content SD in the storage 102.

A second scheme will be described next. In the second scheme, the user uses the reception apparatus 1 in the home (see FIG. 1) where the delivery apparatus 5 is placed. The reception apparatus 1 and the delivery apparatus 5 directly connect to each other through, for example, wireless communication via the wireless communication unit 105 in the reception apparatus 1 and the network interface 505 in the delivery apparatus 5, as described in the registration processing in step S1.

By operating the touch panel or the like of the reception apparatus 1, the user issues an instruction to the control unit 10 in the reception apparatus 1 in FIG. 3 so as to obtain low-image-quality video content SD. In response to the instruction, the request unit 13 in the control unit 10 issues a request to the control unit 51 in the delivery apparatus 5 in FIG. 5 so as to transfer the low-image-quality video content SD to the reception apparatus 1.

In response to the request, the control unit 51 in the delivery apparatus 5 issues an instruction to the image-quality converting unit 52 so as to generate the low-image-quality video content SD from high-image-quality video content HD.

In response to the instruction, the image-quality converting unit 52 reads the high-image-quality video content HD from the storage 502 and generates the low-image-quality video content SD having a reduced image quality. Upon completing the generation of the low-image-quality video content SD, the image-quality converting unit 52 outputs the generated low-image-quality video content SD to the encoding unit 54. The encoding unit 54 encodes (compresses and encrypts) the low-image-quality video content SD input from the image-quality converting unit 52 and outputs the resulting low-image-quality video content SD to the input/output-data processing unit 53.

The input/output-data processing unit 53 directly transfers the low-image-quality video content SD, encoded by and input from the encoding unit 54, to the reception apparatus 1 in FIG. 3 via the network interface 505. The wireless communication unit 105 in the reception apparatus 1 outputs the transferred low-image-quality video content SD to the input/output-data processing unit 15. The storage control unit 14 issues an instruction to the input/output-data processing unit 15 so as to store the input low-image-quality video content SD in the storage 102.

In response to the instruction, the input/output-data processing unit 15 stores, in the storage 102, the low-image-quality video content SD input from the wireless communication unit 105. With the first scheme or the second scheme described above, the low-image-quality video content SD is stored in the storage 102, as illustrated in FIG. 3.

In step S3, the reception apparatus 1 establishes a connection with the delivery apparatus 5, the connection passing through the base station 2, the core network 3, and the Internet 4. More specifically, when the user takes the reception apparatus 1 out of the home and moves into the communication area of the base station 2, as indicated by reference numeral A1 in FIG. 1, the wireless communication unit 105 in the reception apparatus 1 connects to the base station 2. Since the reception apparatus 1 is taken out of the home, the direct connection between the wireless communication unit 105 in the reception apparatus 1 and the network interface 505 in the delivery apparatus 5 is broken.

When the wireless communication unit 105 in the reception apparatus 1 connects to the base station 2, the request unit 13 issues a connection request to the delivery apparatus 5. In response to the connection request, the control unit 51 in the delivery apparatus 5 connects to the reception apparatus 1. Upon the connection, a connection between the reception apparatus 1 and the delivery apparatus 5 is established, so that a communication through the base station 2, the core network 3, and the Internet 4 is made possible, as described above with reference to FIG. 1.

In step S4, by operating the touch panel or the like of the reception apparatus 1 in FIG. 3, the user issues, to the control unit 10 in the reception apparatus 1, a transmission request for transmitting a list of video content that can be delivered by the delivery apparatus 5 in FIG. 5 (the list is hereinafter referred to as a “video content list”, as appropriate). In response to the instruction, the request unit 13 in the control unit 10 issues a request to the control unit 51 in the delivery apparatus 5 in FIG. 5 so as to transmit the video content list to the reception apparatus 1.

In step S5, in response to the transmission request, the control unit 51 in the delivery apparatus 5 in FIG. 5 generates a list of one or more pieces of video content that are stored in the storage 502 and that can be delivered and transmits the video content list to the reception apparatus 1 in FIG. 3 via the network interface 505. The video content list includes the name(s) of the video content, a total time from start to end, and an image quality (for example, the resolution and bit rate).

In step S6, the control unit 10 in the reception apparatus 1 in FIG. 3 receives the video content list transmitted from the delivery apparatus 5 in FIG. 5 and displays the video content list on the display device 106.

In step S7, by operating the touch panel or the like of the reception apparatus 1 in FIG. 3, the user selects, from the displayed video content list, video content he or she wishes to view and listen to. The selected video content has the same contents as those of the low-image-quality video content SD already stored in the storage 102 and corresponds to the high-image-quality video content HD illustrated in FIG. 5.

In step S8, the request unit 13 in the reception apparatus 1 in FIG. 3 issues a request to the control unit 51 in the delivery apparatus 5 in FIG. 5 so as to deliver, to the reception apparatus 1, the video content selected in step S7 (the high-image-quality video content HD in FIG. 5, in the example in step S7).

In step S9, in response to the delivery request, the control unit 51 in the delivery apparatus 5 delivers the high-image-quality video content HD to the reception apparatus 1 in FIG. 3. More specifically, in response to the delivery request, the control unit 51 in the delivery apparatus 5 issues an instruction to the encoding unit 54 so as to read the high-image-quality video content HD from the storage 502 and encode the high-image-quality video content HD.

In response to the instruction, the encoding unit 54 reads the high-image-quality video content HD from the storage 502, encodes the high-image-quality video content HD for each predetermined data unit, and outputs the resulting data to the input/output-data processing unit 53. The input/output-data processing unit 53 packetizes the data input from the encoding unit 54 and transmits the packetized data to the Internet 4 (see FIG. 1) via the network interface 505.

The packet has a header field and a payload field. The header field includes an identifier for uniquely identifying the reception apparatus 1 as the destination address of the packet. The payload field contains video data and audio data of the high-image-quality video content HD. The video data and the audio data contained in the packet is delivered to the reception apparatus 1 through the Internet 4, the core network 3, and the base station 2.

In step S10, the reception apparatus 1 receives the high-image-quality video content HD delivered from the delivery apparatus 5 and sequentially plays back the high-image-quality video content HD. More specifically, the wireless communication unit 105 in the reception apparatus 1 illustrated in FIG. 2 receives transmission signals including the video data and audio data of the high-image-quality video content HD, the transmission signals being transmitted from the base station 2, demodulates and decodes the received signals, and outputs the decoded data to the input/output-data processing unit 15.

The input/output-data processing unit 15 outputs the data, output by the wireless communication unit 105, to the decoding unit 16. The decoding unit 16 decodes the data output by the input/output-data processing unit 15 and outputs the decoded data to the playback unit 17.

The playback unit 17 displays, on the display device 106, high-image-quality video based on the video data output by the decoding unit 16. The playback unit 17 then outputs, from the speaker 107, high quality sound based on the audio data output by the decoding unit 16.

After start of sequential playback of the high-image-quality video content HD, the determining unit 11 determines, for example, at a predetermined timing, whether or not the sequential playback of the high-image-quality video content HD is continuable.

In step S11, the determining unit 11 determines that the sequential playback of the high-image-quality video content HD is not continuable.

In step S12, at the timing at which the determining unit 11 determines that the sequential playback of the high-image-quality video content HD is not continuable (this timing is hereinafter referred to as a “determination timing”, as appropriate), the control unit 10 stores, in the storage 102, information regarding the video content and including a playback position of the high-image-quality video content HD that has been sequentially played back.

The playback position is indicated by a time difference between the playback start time of the high-image-quality video content HD and the time of the determination timing in step S12. For example, it is assumed that the playback start time is 12:05:10 and the time of the determination timing is 13:10:20. In this example, the playback position is 1:05:10 (13:10:20-12:05:10).

The information regarding the video content during the sequential playback includes, for example, the aforementioned playback position, the title of the video content, the resolution and bit rate of the video content, information (also called a file path) indicating the video content storage location in the delivery apparatus 5.

In addition, the control unit 10 stops the sequential playback of the high-image-quality video content HD. More specifically, the control unit 10 issues a stop instruction to the decoding unit 16 so as to stop the decoding of the high-image-quality video content HD. In response to the stop instruction, the decoding unit 16 stops the decoding of the high-image-quality video content HD. As a result, the high-image-quality video content HD sequential playback performed by the playback unit 17 stops.

In step S13, the content-switching control unit 12 reads, from the storage 102, low-image-quality video content SD having the same contents as those of the high-image-quality video content HD that has been sequentially played back, and issues an instruction to the decoding unit 16 so as to decode the read low-image-quality video content SD. At the same time, the content-switching control unit 12 issues an instruction to the decoding unit 16 so as to decode the low-image-quality video content SD from the playback position described in step S12.

In the example described above, the playback position is 1:05:10, and in this example, the content-switching control unit 12 issues an instruction to the decoding unit 16 so as to decode the low-image-quality video content SD at the position of 1:05:10 from the start of the low-image-quality video content SD. In response to the instruction, the decoding unit 16 reads the low-image-quality video content SD from the storage 102.

In step S14, the playback unit 17 plays back the low-image-quality video content SD. More specifically, the decoding unit 16 reads the low-image-quality video content SD from the storage 102, decodes the data of the low-image-quality video content SD from the playback position, and outputs the decoded data to the playback unit 17.

The playback unit 17 displays, on the display device 106, low-image quality video based on the video data output by the decoding unit 16. The playback unit 17 outputs, from the speaker 107, low quality sound based on the audio data output by the decoding unit 16.

According to the reception apparatus 1 described above, even when the quality of wireless communication decreases or it is difficult to perform wireless communication and consequently the sequential playback of high-image-quality video content HD is not continuable, content to be played back is switched from the high-image-quality video content HD to low-image-quality video content SD that is already stored in the reception apparatus 1. Thus, according to the reception apparatus 1, even when the sequential playback of the high-image-quality video content HD is not continuable, it is possible to play back the video content. Accordingly, the user of the reception apparatus 1 can continuously view and listen to the low-image-quality video content SD, although he or she is not able to view and listen to the high-image-quality video content HD. As a result, the convenience of the user of the reception apparatus increases.

The resolution and bit rate of low-image-quality video content SD are also lower than the resolution and bit rate of the high-image-quality video content HD. Thus, in the reception apparatus, the data throughput when the low-image-quality video content SD is decoded and played back is lower than the data throughput when the high-image-quality video content HD is decoded and played back.

When the data throughput is reduced, the electric power used for the data processing is reduced. Accordingly, the power consumption used to decode and play back the low-image-quality video content SD is lower than the power consumption used to decode and play back the high-image-quality video content HD.

In the reception apparatus 1 according to the present embodiment, since content to be played back is switched from high-image-quality video content HD to low-image-quality video content SD that is already stored in the reception apparatus 1, it is possible to reduce the power consumption in the reception apparatus 1. In particular, when the reception apparatus 1 according to the present embodiment is a mobile terminal powered by a battery, the reduction in the power consumption makes it possible to extend the operating time.

(Second Switching Processing for Switching from High-Image-Quality Video Content HD to Low-Image-Quality Video Content SD)

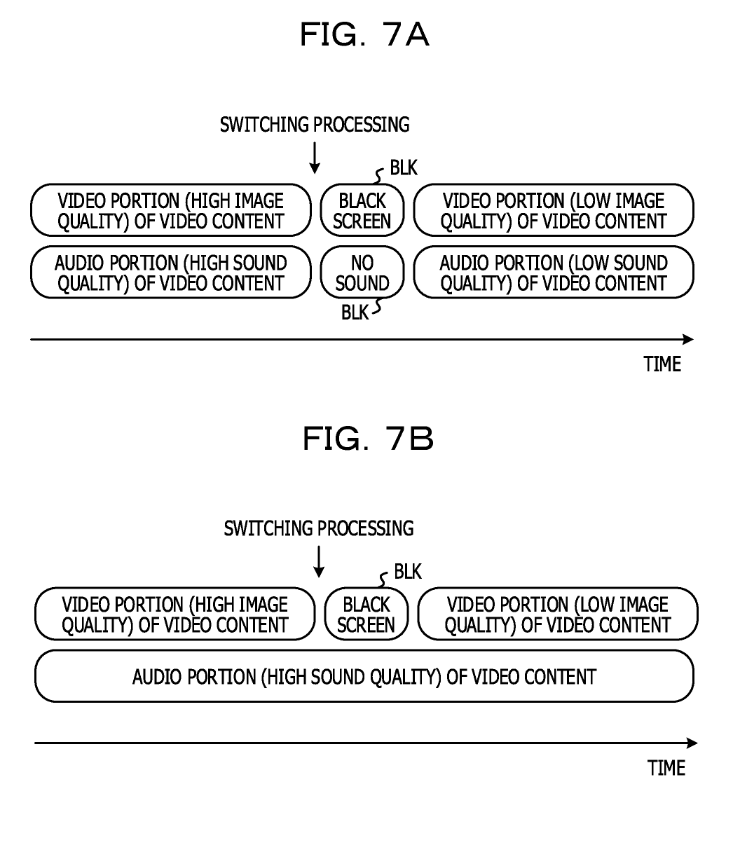

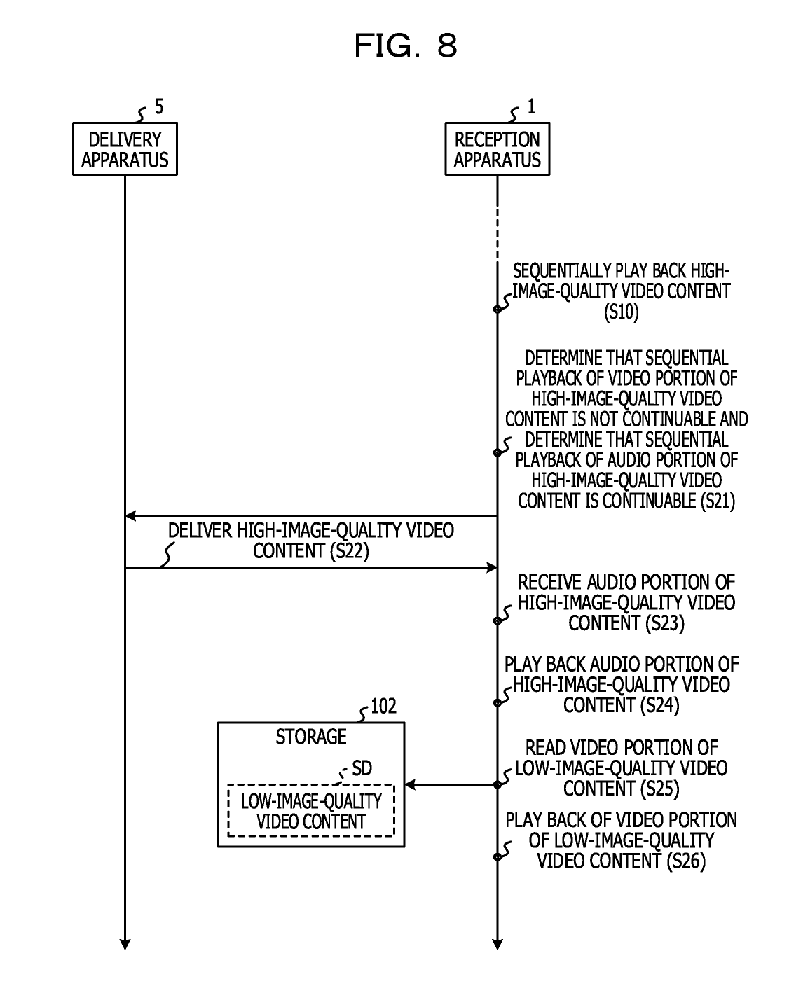

Second switching processing for switching from high-image-quality video content HD to low-image-quality video content SD will now be described with reference to FIGS. 7A and 7B and FIG. 8.

FIGS. 7A and 7B are time charts illustrating examples of the second switching processing for switching from high-image-quality video content HD to low-image-quality video content SD.

In the following description, video data contained in video content is referred to as video portion of video content, and audio data contained in video content is referred to as audio portion of video content, as appropriate. The image quality of the video portion of the high-image-quality video content HD is a high image quality, and the sound quality of the audio portion is a high sound quality. The image quality of the video portion of the low-image-quality video content SD is a low-image quality, and the sound quality of the audio portion is a low sound quality.

In FIGS. 7A and 7B, the display state of high-image-quality video is indicated by “video portion (high image quality) of video content”, and the display state of low-image quality video is indicated by “video portion (low-image quality) of video content”. The output state of high quality sound is indicated by “audio portion (high sound quality) of video content”, and the output state of low quality sound is indicated by “audio portion (low sound quality) of video content”. In FIGS. 7A and 7B, the passage of time is indicated by an arrow from left to right.

For example, when processing load on the CPU 101 in the reception apparatus 1 is high, there are cases in which a few seconds of time is taken until switching processing for switching from high-image-quality video content HD to low-image-quality video content SD is completed. In the few seconds of time, no video is displayed (black screen), and also no sound is output, as indicated by reference characters BLK in FIG. 7A. Thus, the user of the reception apparatus 1 is neither able to view video nor able to listen to sound, during the time indicated by reference character BLK in FIG. 7A.

Even if the sequential playback of the video portion of high-image-quality video content HD is not continuable, when the sequential playback of the audio portion (high sound quality) of the high-image-quality video content HD is continuable, the user can more comfortably view and listen to the video content when listening to the high quality sound. In this case, the amount of data of the audio portion of the high-image-quality video content HD is smaller than the amount of data of the video portion, even when the audio portion has a high sound quality. Thus, even when the sequential playback of the video portion of high-image-quality video content HD is not continuable, there are cases in which the sequential playback of the audio portion of the high-image-quality video content HD is continuable.

Accordingly, the reception apparatus 1 executes the following processing. First, the determining unit 11 makes a third determination as to whether or not sequential playback of video portion of high-image-quality video content HD is continuable and a fourth determination as to whether or not sequential playback of audio portion of the high-image-quality video content HD is continuable.

When it is determined in the third determination that the sequential playback of the video portion is not continuable and it is determined in the fourth determination that the sequential playback of the audio portion is continuable, the content-switching control unit 12 executes the following processing. That is, as illustrated in FIG. 7B, the content-switching control unit 12 executes switching processing for switching the video portion of the video content to be played back by the playback unit 17 from the video portion of the high-image-quality video content HD to the video portion of the low-image-quality video content SD. Upon executing the switching processing, the content-switching control unit 12 makes the playback unit 17 continue the sequential playback of the audio portion (high sound quality) of the high-image-quality video content HD, as illustrated in FIG. 7B.

The third determination is substantially the same as the first determination described above with reference to FIG. 3. The determining unit 11 determines (in the fourth determination) that the sequential playback of the audio portion of the high-image-quality video content HD is continuable (hereinafter referred to as “audio sequential playback is possible”, as appropriate), by using one of the following five determination schemes.

A first determination scheme is a scheme for determining whether or not the wireless error rate in wireless communication is higher than or equal to a pre-defined second reference wireless error rate. When the wireless error rate determined by the input/output-data processing unit 15 is lower than the second reference wireless error rate, the determining unit 11 determines that the audio sequential playback is possible. The second reference wireless error rate is higher than the first reference wireless error rate described above with reference to FIG. 3. The second reference wireless error rate is a wireless error rate pre-defined by the developer of the reception apparatus 1 through an experiment or the like.

A second determination scheme is a scheme for determining whether or not the amount of audio data used for sequential playback is received within a first reference time. The input/output-data processing unit 15 determines an amount of audio data of video content received by the wireless communication unit 105 within the first reference time and outputs the amount of audio data to the determining unit 11. When the amount of audio data determined by the input/output-data processing unit 15 is larger than or equal to the amount of audio data used for the sequential playback, the determining unit 11 determines that the audio sequential playback is possible. The amount of audio data used for sequential playback and the first reference time are pre-determined by the developer of the reception apparatus 1 through an experiment or the like.

A third determination scheme is a scheme for determining whether or not the radio-wave strength in wireless communication with the base station 2, the radio-wave strength being measured by the wireless communication unit 105, is smaller than a second reference radio-wave strength. When the radio-wave strength measured by the wireless communication unit 105 is greater than or equal to the second reference radio-wave strength, the determining unit 11 determines that the audio sequential playback is possible. The second reference radio-wave strength is lower than the first reference radio-wave strength described above with reference to FIG. 3. The second reference radio-wave strength is a radio-wave strength pre-defined by the developer of the reception apparatus 1 through an experiment or the like.

A fourth determination scheme is a scheme for determining whether or not the loss rate of communication packets contained in transmission signals transmitted from the base station 2 to the reception apparatus 1 in wireless communication between the base station 2 and the reception apparatus 1 is higher than or equal to a second reference loss rate. When the loss rate determined by the wireless communication unit 105 or the input/output-data processing unit 15 is lower than the second reference loss rate, the determining unit 11 determines that the audio sequential playback is possible. The second reference loss rate is higher than the first reference loss rate. The second reference loss rate is a loss rate pre-defined by the developer of the reception apparatus 1 through an experiment or the like.

A fifth determination scheme is a scheme for determining whether or not an elapsed time from when the control unit 10 issues an “HTTP GET” request to the delivery apparatus 5 until the control unit 10 receives, from the delivery apparatus 5, a response to the “HTTP GET” request exceeds a second time. When the elapsed time is smaller than or equal to the second time, the determining unit 11 determines that the audio sequential playback is possible. The second time is larger than the first time described above with reference to FIG. 3. The second time is pre-defined by the developer of the reception apparatus 1 through an experiment or the like.

FIG. 8 is a sequence diagram illustrating an example of the second switching processing for switching video content to be played back from high-image-quality video content HD to low-image-quality video content SD while sequentially playing back the audio portion (high sound quality) of the high-image-quality video content HD.

In the description given with reference to FIG. 8, the high-image-quality video content HD is being sequentially played back, as described above with reference to FIG. 6 (see step S10 in FIG. 6). For example, at each predetermined timing after start of the sequential playback of the high-image-quality video content HD, the determining unit 11 makes the third determination as to whether or not the sequential playback of the video portion of the high-image-quality video content HD is continuable and the fourth determination as to whether or not the sequential playback of the audio portion of the high-image-quality video content HD is continuable. During the sequential playback of the high-image-quality video content HD, the quality of wireless communication with the base station 2 decreases (see reference character A3 in FIG. 1).

In step S21, the determining unit 11 determines that the sequential playback of the video portion of the high-image-quality video content HD is not continuable and determines that the sequential playback of the audio portion of the high-image-quality video content HD is continuable.

In step S22, the delivery apparatus 5 continues the delivery of the high-image-quality video content HD.

In step S23, the wireless communication unit 105 in the reception apparatus 1 receives the audio portion (high sound quality) of the high-image-quality video content HD delivered from the delivery apparatus 5. The wireless communication unit 105 then demodulates and decodes the received audio portion and outputs the resulting data to the input/output-data processing unit 15.

In step S24, the playback unit 17 plays back the audio portion (high sound quality) of the high-image-quality video content HD. More specifically, the decoding unit 16 decodes the encrypted audio portion (audio data) in the data output by the input/output-data processing unit 15. When the decoded audio data is compressed data, the decoding unit 16 decompresses the decoded audio data. The playback unit 17 then outputs, from the speaker 107, high quality sound based on the audio data output by the decoding unit 16.

In step S25, the content-switching control unit 12 issues an instruction to the decoding unit 16 so as to read, from the storage 102, the video portion of the low-image-quality video content SD having the same contents as those of the high-image-quality video content HD that has been sequentially played back and so as to decode the read video portion. At the same time, in synchronization with the playback position (playback timing) at which the audio portion of the high-image-quality video content HD is sequentially played back, the content-switching control unit 12 issues an instruction to the decoding unit 16 so as to decode the low-image-quality video content SD starting from the playback position at which video corresponding to the audio is displayed. In response to the instruction, the decoding unit 16 reads the video portion of the low-image-quality video content SD from the storage 102.

In step S26, the playback unit 17 plays back the low-image-quality video content SD. More specifically, the decoding unit 16 reads the video portion of the low-image-quality video content SD from the storage 102. Then, in synchronization with the playback position (playback timing) at which the audio portion is sequentially played back, the decoding unit 16 decodes the video portion of the low-image-quality video content SD starting from the playback position at which the video corresponding to the sound is displayed, and outputs the decoded video portion to the playback unit 17.

Thereafter, when the sequential playback of the audio portion of the high-image-quality video content HD is not continuable, the video portion and the audio portion of the low-image-quality video content SD are played back (see steps S12 to S14), as described above with reference to FIG. 6.

According to the reception apparatus 1 described above, when the sequential playback of the video portion of high-image-quality video content HD is not continuable but the sequential playback of the audio portion (high sound quality) of the high-image-quality video content HD is continuable, the sequential playback of the high-sound-quality audio portion is continued. Accordingly, even if a black screen is displayed as a result of switching of the video content, as described in FIGS. 7A and 7B, sound is output while the black screen is displayed.

As a result, the user of the reception apparatus 1 can listen to at least the sound of the video content. In addition, since the high quality sound is played back, the user of the reception apparatus 1 can listen to the high quality sound even when low-image quality video is displayed after switching the video content.

After step S21, the request unit 13 in the reception apparatus 1 may also issue a request to the delivery apparatus 5 so as to stop the delivery of the video portion and the audio portion of the high-image-quality video content HD and so as to deliver only the audio portion of the high-image-quality video content HD to the reception apparatus 1.

In response to the delivery request, the control unit 51 in the delivery apparatus 5 in FIG. 5 issues an instruction to the encoding unit 54 so as to read the high-image-quality video content HD from the storage 502 and so as to encode only the audio portion. In response to the instruction, the encoding unit 54 encodes only the audio portion of the high-image-quality video content HD for each predetermined data unit and outputs the encoded audio portion to the input/output-data processing unit 53. The input/output-data processing unit 53 packetizes data (only the data of the audio portion) input from the encoding unit 54 and transmits the packetized data to the Internet 4 (see FIG. 1) via the network interface 505.

When only the audio portion of the high-image-quality video content HD is delivered, the communication band of the wired communication path and/or the wireless communication path between the reception apparatus 1 and the delivery apparatus 5 is not squeezed, compared with a case in which the video portion and the audio portion of the high-image-quality video content HD are delivered.

(Switching Processing for Switching Low-Image-Quality Video Content SD to High-Image-Quality Video Content HD)

Next, assume a case in which the reception apparatus 1 is located in the communication area of the base station 2 during playback of low-image-quality video content SD and further the quality of the wireless communication improves to make it possible to continue sequential playback of high-image-quality video content HD. In this case, the reception apparatus 1 switches the video content to be played back from the low-image-quality video content SD to the high-image-quality video content HD.

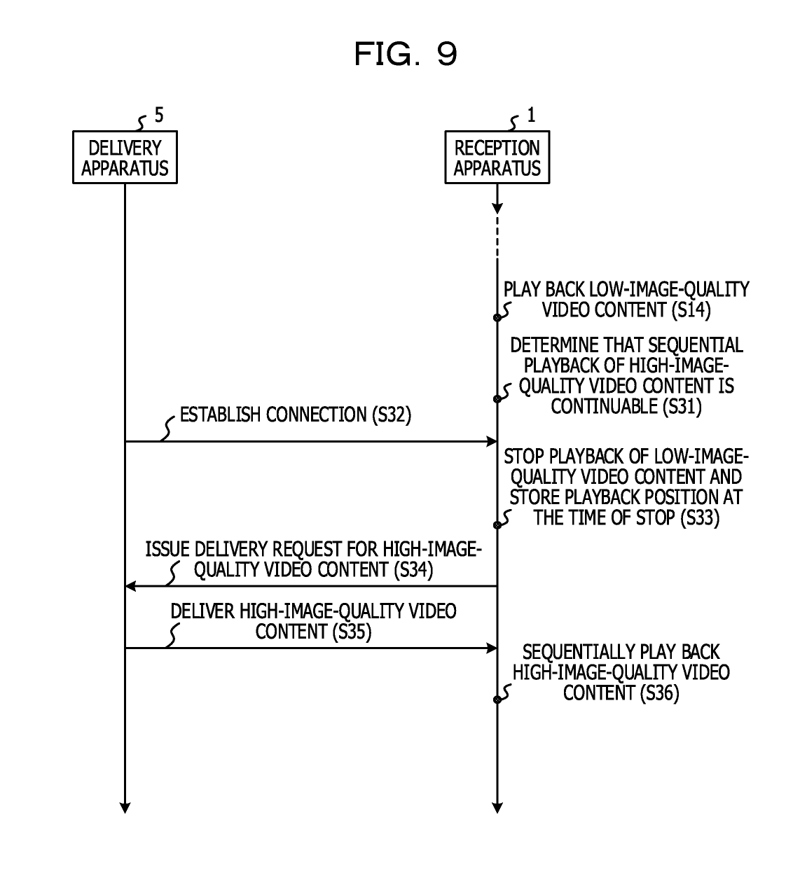

FIG. 9 is a sequence diagram illustrating an example of processing for switching video content to be played back from low-image-quality video content SD to high-image-quality video content HD. In the description given with reference to FIG. 9, it is assumed that the low-image-quality video content SD is being played back (see step S14 in FIG. 6), as described above with reference to FIG. 6.

Before a description of step S31 is given, it is assumed that the reception apparatus 1 is located in the communication area of the base station 2 and the quality of the wireless communication improves to thereby make it possible to continue the sequential playback of the high-image-quality video content HD.

In step S31, the determining unit 11 in the reception apparatus 1 in FIG. 3 determines that the sequential playback of the high-image-quality video content HD is continuable.

In step S32, the reception apparatus 1 establishes a connection with the delivery apparatus 5. Since this connection establishment is substantially the same as that described above with reference to step S3 in FIG. 6, a description thereof is not given hereinafter. This connection establishment is executed when the reception apparatus 1 moves out of the communication area of the base station 2, the connection with the base station 2 and the delivery apparatus 5 is broken, and then the reception apparatus 1 moves into the communication area of the base station 2 again.

In step S33, the control unit 10 in the reception apparatus 1 in FIG. 3 stops playback of the low-image-quality video content SD and stores, in the storage 102, information regarding the video content and including a playback position at the time of the stop of the playback. More specifically, the control unit 10 issues an instruction to the decoding unit 16 so as to stop the decoding of the low-image-quality video content SD. In response to the stop instruction, the decoding unit 16 stops the decoding of the low-image-quality video content SD. As a result, the playback of the low-image-quality video content SD, the playback being performed by the playback unit 17, stops.

In step S34, the request unit 13 in the reception apparatus 1 in FIG. 3 issues a request to the control unit 51 in the delivery apparatus 5 in FIG. 5 so as to deliver the video content selected in step S7 in FIG. 6 (in the example in step S7, the high-image-quality video content HD illustrated in FIG. 5) to the reception apparatus 1. In this case, the request unit 13 may also transmit the playback position stored in the storage 102 in step S33 to the control unit 51 in the delivery apparatus 5, and may also issue a delivery request so as to deliver the high-image-quality video content HD starting from the playback position.

In step S35, in response to the delivery request, the control unit 51 in the delivery apparatus 5 delivers the high-image-quality video content HD to the reception apparatus 1 in FIG. 3. Upon receiving the delivery request issued together with the playback position described above in step S34, the control unit 51 in the delivery apparatus 5 executes the following processing. That is, in response to the delivery request, the control unit 51 issues an instruction to the encoding unit 54 so as to read, from the storage 502, the data of the high-image-quality video content HD starting at the playback position and so as to encode the read data.

In response to the instruction, the encoding unit 54 reads, from the storage 502, the data of the high-image-quality video content HD starting at the playback position, encodes the read data for each predetermined data unit, and outputs the encoded data to the input/output-data processing unit 53. The input/output-data processing unit 53 packetizes the data input from the encoding unit 54 and transmits the packetized data to the Internet 4 (see FIG. 1) via the network interface 505.

In step S36, the reception apparatus 1 receives the high-image-quality video content HD delivered from the delivery apparatus 5 and sequentially plays back the received high-image-quality video content HD. More specifically, the content-switching control unit 12 issues an instruction to the decoding unit 16 so as to decode the video data and audio data, output by the input/output-data processing unit 15, starting at a position corresponding to the aforementioned playback position and outputs the decoded video data and audio data to the playback unit 17.

As described above with reference to step S10 in FIG. 6, in response to the decode instruction, the decoding unit 16 decodes the video data and audio data, output by the input/output-data processing unit 15, starting at a position corresponding to the aforementioned playback position, and outputs the decoded video data and audio data to the playback unit 17. Thereafter, the playback unit 17 outputs the video data to the display device 106 in FIG. 2 and outputs the audio data to the speaker 107 in FIG. 2, as described above with reference to step S10 in FIG. 6.

While the playback unit 17 sequentially plays back the audio portion (high sound quality) of the high-image-quality video content HD described above with reference to FIGS. 7A and 7B and FIG. 8 and plays back the video portion of the low-image-quality video content SD, there are cases in which the determining unit 11 determines that the sequential playback of the high-image-quality video content HD is continuable. In this case, the content-switching control unit 12 switches the video portion of the video content to be played back by the playback unit 17 from the video portion of the low-image-quality video content SD to the video portion of the high-image-quality video content HD, as described above with reference to FIG. 9.

As described above with reference to FIG. 9, when the continuation of the sequential playback of the high-image-quality video content HD becomes possible, the reception apparatus 1 switches the video content to be played back from the low-image-quality video content SD to the high-image-quality video content HD. As a result of the switching of the video content, the user of the reception apparatus 1 can view and listen to the high-image-quality video content HD, and thus can comfortably view and listen to the video content.

(Flow of Switching Processing for Switching from High-Image-Quality Video Content HD to Low-Image-Quality Video Content SD)

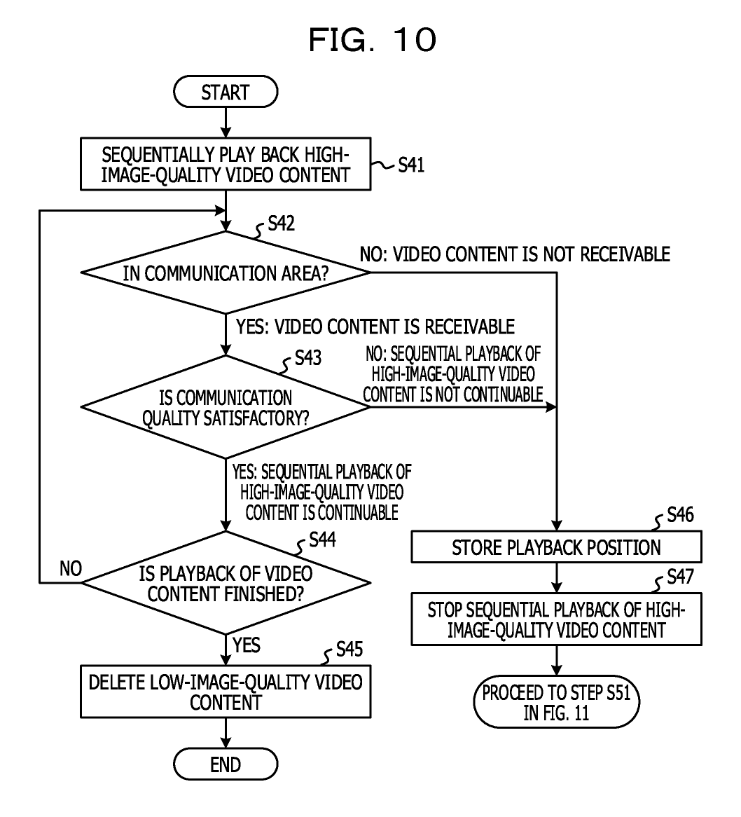

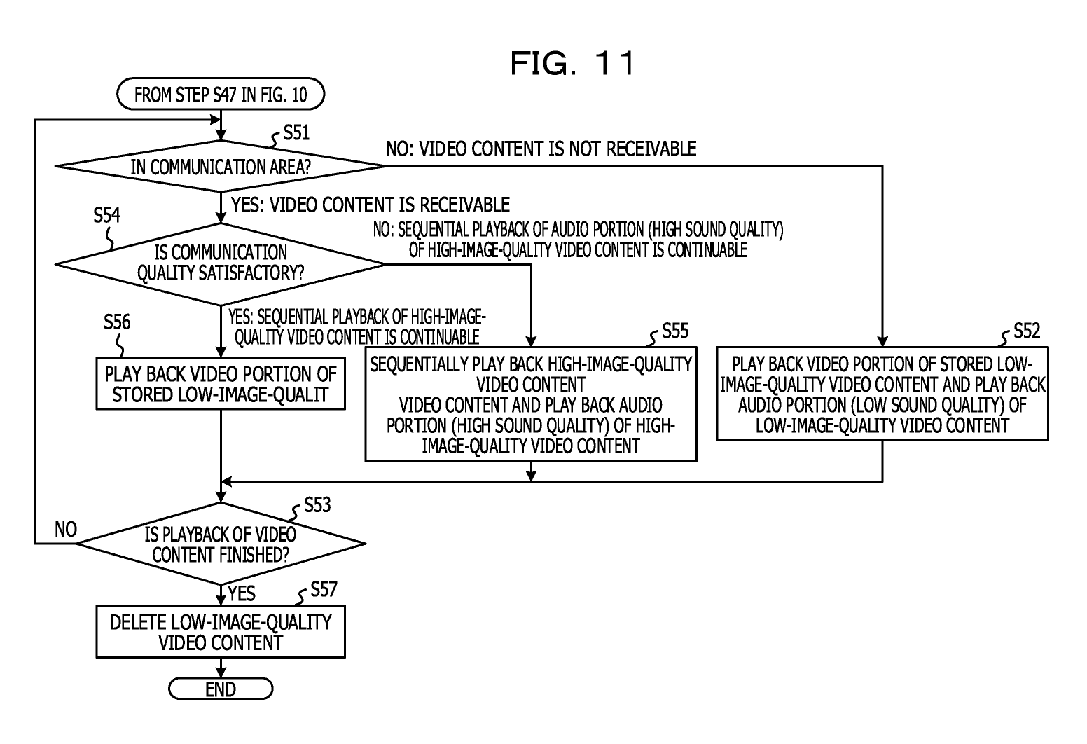

The switching processing for switching from high-image-quality video content HD to low-image-quality video content SD, the switching processing being performed by the reception apparatus 1, will be described below with reference to FIGS. 10 and 11.

FIGS. 10 and 11 are first and second flowcharts illustrating a flow of the switching processing for switching from high-image-quality video content HD to low-image-quality video content SD, the switching processing being performed by the reception apparatus 1.

It is assumed that, before processing described with reference to FIG. 10 is executed, the processes from the registration of the reception apparatus 1 (step S1 in FIG. 6) to the delivery of the high-image-quality video content HD (step S9 in FIG. 6) have already been executed.

In step S41, the playback unit 17 in the reception apparatus 1 in FIG. 3 sequentially plays back the high-image-quality video content HD. Since a description in step S41 is substantially the same as that in step S10 in FIG. 6, a detailed description is not given hereinafter.

In steps S42 and S43 described below, a determination is made as to whether or not the switching processing is to be executed on the video content to be played back.

In step S42, the determining unit 11 determines whether or not the reception apparatus 1 is located in the communication area of the base station 2. The determining unit 11 makes the determination as to whether or not the reception apparatus 1 is located in the communication area of the base station 2, for example, by determining whether or not the radio-wave strength in wireless communication with the base station 2, the radio-wave strength being measured by the wireless communication unit 105, is lower than a reference radio-wave strength.

If the reception apparatus 1 is located in the communication area of the base station 2 (YES in step S42), that is, if video content is receivable regardless of whether the image quality is a low-image quality or a high image quality, the process proceeds to step S43.

In step S43, the determining unit 11 determines whether or not the communication quality of the wireless communication between the reception apparatus 1 and the base station 2 is satisfactory. In this case, the determining unit 11 determines whether or not the sequential playback of the high-image-quality video content HD is continuable.

If the communication quality is satisfactory (YES in step S43), that is, if the sequential playback of the high-image-quality video content HD is continuable, the process proceeds to step S44.

In step S44, the control unit 10 determines whether or not the playback of the high-image-quality video content HD that is sequentially played back is finished. If the playback of the high-image-quality video content HD is not finished (NO in step S44), the process returns to step S42. If the playback of the high-image-quality video content HD is finished (YES in step S44), the process proceeds to step S45.

In step S45, the control unit 10 deletes the low-image-quality video content SD stored in the storage 102. This process is performed in order to delete one piece of video content, when permanent storage of video content having the same content in two or more devices (or media) is prohibited from the viewpoint of copyright protection, regardless of whether the image quality is a high image quality or low-image quality.

When a copy counter for the high-image-quality video content HD is set from the viewpoint of copyright protection, the delivery apparatus 5 increments the copy counter for the high-image-quality video content HD by “1”, upon generating low-image-quality video content SD from the high-image-quality video content HD. When the copy counter is incremented by “1” in such a manner, the request unit 13 in the reception apparatus 1 issues a request to the delivery apparatus 5 so as to decrement the copy counter by “1” via deletion of the low-image-quality video content SD. In response to the request, the control unit 51 in the delivery apparatus 5 decrements the copy counter for the high-image-quality video content HD by “1”.

If the playback of the high-image-quality video content HD is not finished (NO in step S44), the process returns to step S42.

If the reception apparatus 1 is not located in the communication area of the base station 2 (NO in step S42), that is, if the video content is not receivable regardless of whether the image quality is a low image quality or high image quality, the process proceeds to step S46. If the communication quality is not satisfactory (NO in step S43), that is, if the sequential playback of the high-image-quality video content HD is not continuable (NO in step S43), the process proceeds to step S46. After step S46, switching processing for switching the video content to be played back is executed.

In step S46, when the determining unit 11 determines that the sequential playback of the high-image-quality video content HD is not continuable, the control unit 10 stores, in the storage 102, information regarding the video content and including the playback position of the high-image-quality video content HD that has been sequentially played back at the determination timing.

In step S47, the control unit 10 stops the sequential playback of the high-image-quality video content HD. Since descriptions in steps S46 and S47 are substantially the same as those in step S12 in FIG. 6, detailed descriptions are not given hereinafter. A description will be given of step S51 in FIG. 11.

In step S51 in FIG. 11, the determining unit 11 determines whether or not the reception apparatus 1 is located in the communication area of the base station 2. The process in step S51 is substantially the same as the above-described process in step S42 in FIG. 10. If the reception apparatus 1 is not located in the communication area of the base station 2 (NO in step S51), the process proceeds to step S52.

In step S52, the playback unit 17 plays back the low-image-quality video content SD already stored in the storage 102, the low-image-quality video content SD having the same contents as those of the high-image-quality video content HD that has been sequentially played back. In step S52, the video portion and the audio portion (low sound quality) of the low-image-quality video content SD are played back. Since a description in step S52 is substantially the same as that in steps S13 and S14 in FIG. 6, a detailed description is not given hereinafter.

In step S53, the control unit 10 determines whether or not the playback of the video content being played back is finished. When the playback of the video content is not finished (NO in step S53), the process returns to step S51.

When the determining unit 11 determines that the reception apparatus 1 is located in the communication area of the base station 2 (YES in step S51), the process proceeds to step S54.

In step S54, the determining unit 11 determines whether or not the communication quality of the wireless communication between the reception apparatus 1 and the base station 2 is satisfactory. In this determination, the determining unit 11 determines whether or not the sequential playback of the high-image-quality video content HD is continuable and further determines whether or not the sequential playback of the audio portion of the high-image-quality video content HD is continuable. If the communication quality of the wireless communication between the reception apparatus 1 and the base station 2 is not satisfactory (NO in step S54), that is, if the sequential playback of the high-image-quality video content HD (the video portion and the audio portion) is not continuable, but the sequential playback of the audio portion of the high-image-quality video content HD is continuable, the process proceeds to step S55.

In step S55, the playback unit 17 plays back the video portion of the low-image-quality video content SD already stored in the storage 102 and also sequentially plays back the audio portion (high sound quality) of the high-image-quality video content HD. Since a description in step S55 is substantially the same as that in steps S23 to S26 in FIG. 8, a detailed description is not given hereinafter.

If the quality of the wireless communication improves and the communication quality of the wireless communication between the reception apparatus 1 and the base station 2 becomes satisfactory (YES in step S54), that is, if the sequential playback of the high-image-quality video content HD is continuable, the process proceeds to step S56.

In step S56, the playback unit 17 sequentially plays back the high-image-quality video content HD. Step S56 is executed if the reception apparatus 1 is located outside the communication area of the base station 2 (NO in step S51), the reception apparatus 1 is then located in the communication area, and the communication quality becomes satisfactory (YES in step S54). Alternatively, step S56 is executed if the communication quality is not satisfactory (NO in step S54) and then the communication quality becomes satisfactory (YES in step S54). Since the process in step S56 is substantially the same as that described in step S31 in FIG. 9 and the subsequent steps, a description thereof is not given hereinafter.

If the playback of the video content is finished (YES in step S53), the process proceeds to step S57.

In step S57, the control unit 10 deletes the low-image-quality video content SD stored in the storage 102, as described above with reference to step S45 in FIG. 10.

In the reception apparatus 1 according to the present embodiment, when the quality of wireless communication decreases or it is difficult to perform wireless communication during sequential playback of high-image-quality video content HD, it is possible to play back low-image-quality video content SD that is already stored in the reception apparatus 1.

It is also conceivable to store the high-image-quality video content HD in the reception apparatus 1 in advance. However, when the total playback time of the high-image-quality video content HD is one hour, the amount of the entire data of the high-image-quality video content HD becomes as large as, for example, several gigabytes. It takes time to transfer such a large amount of data from the delivery apparatus 5 in which the data is stored to the reception apparatus 1. It is not practical to store such a large amount of data in the storage in the reception apparatus 1, since the free space of the storage is squeezed.

However, the amount of data of the low-image-quality video content SD is one-seventh to one-tenth of the amount of data of the high-image-quality video content HD. Thus, the amount of data of the low-image-quality video content SD is smaller than the amount of data of the high-image-quality video content HD.

Accordingly, the time taken for transferring the low-image-quality video content SD from the delivery apparatus 5 to the reception apparatus 1 is shorter than the time taken for transferring the high-image-quality video content HD from the delivery apparatus 5 to the reception apparatus 1. Also, even when the low-image-quality video content SD is stored in the storage 102 in the reception apparatus 1, the capacity of the storage device is not squeezed, compared with a case in which the high-image-quality video content HD is stored in the storage 102 in the reception apparatus 1. Thus, the reception apparatus 1 stores the low-image-quality video content SD in the storage 102 in advance.

### Second Embodiment

In the first embodiment, the reception apparatus 1 has already stored the low-image-quality video content SD in the storage 102, before the high-image-quality video content HD is sequentially played back. In the second embodiment, after the reception apparatus 1 starts sequential playback of the high-image-quality video content HD, the low-image-quality video content SD is received from the delivery apparatus 5 and is stored in the storage 102.

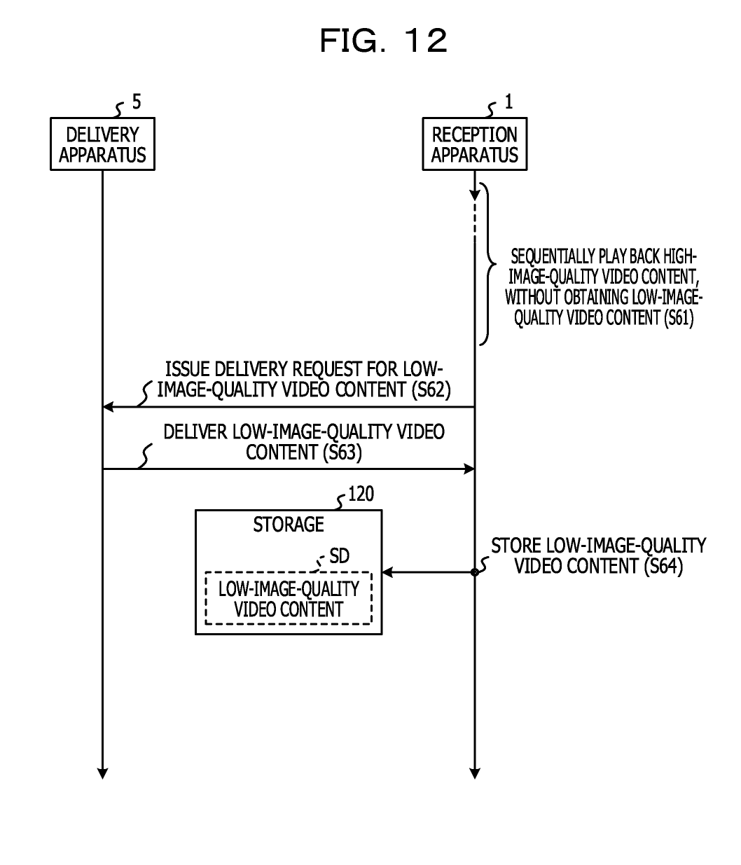

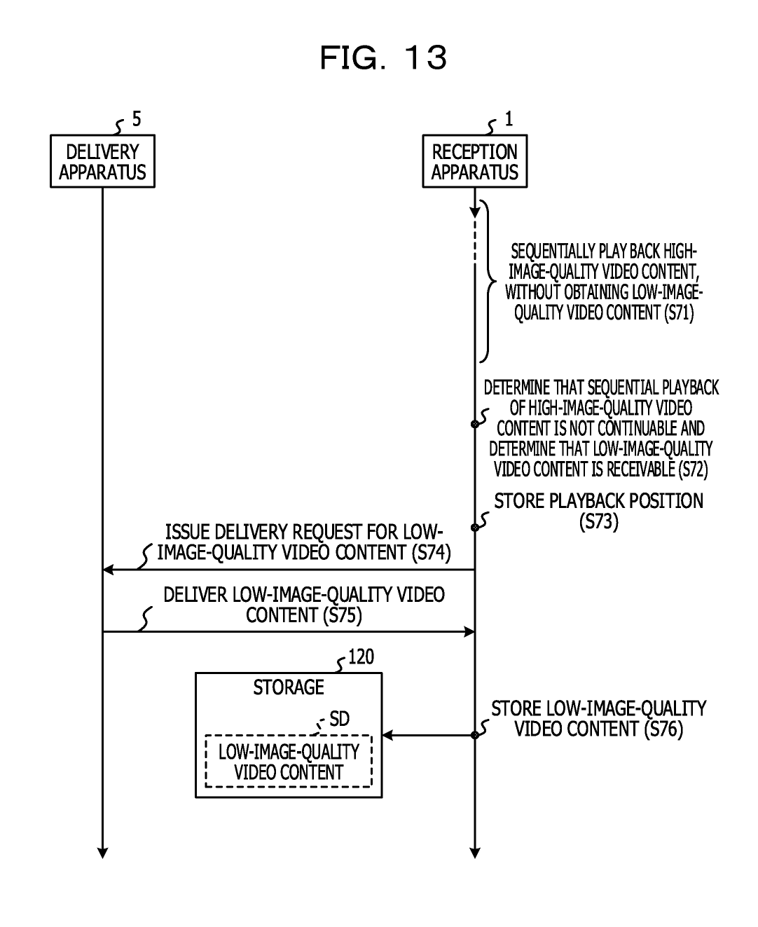

As such processing for storing the low-image-quality video content SD, for example, there are two types of storage processing. First storage processing is a scheme (described below in FIG. 12) in which, while sequentially playing back high-image-quality video content HD, the reception apparatus 1 receives low-image-quality video content SD from the delivery apparatus 5 and stores the low-image-quality video content SD in the reception apparatus 1. Second storage processing is a scheme (described below in FIG. 13) in which, after stopping sequential playback of high-image-quality video content HD, the reception apparatus 1 receives low-image-quality video content SD from the delivery apparatus 5 and stores the low-image-quality video content SD in the reception apparatus 1.

(First Storage Processing for Low-Image-Quality Video Content SD)

First, a description will be given of first processing for receiving low-image-quality video content SD from the delivery apparatus 5 and storing the low-image-quality video content SD in the reception apparatus 1 while the reception apparatus 1 sequentially plays back the high-image-quality video content HD.

FIG. 12 is a sequence diagram illustrating the first storage processing for low-image-quality video content SD.

In step S61, the reception apparatus 1 in FIG. 3 executes the registration of the reception apparatus 1 (step S1 in FIG. 6) and the connection establishment (step S3 in FIG. 6) to the sequential playback of high-image-quality video content HD (step S10 in FIG. 6), without obtaining the low-image-quality video content SD from the delivery apparatus 5, which is described above in step S2 in FIG. 6.

In step S62, the request unit 13 in the reception apparatus 1 in FIG. 3 issues a request to the control unit 51 in the delivery apparatus 5 in FIG. 5 so as to deliver, to the reception apparatus 1, low-image-quality video content SD having the same contents as those of the high-image-quality video content HD that has been sequentially played back.

In step S63, in response to the delivery request, the control unit 51 in the delivery apparatus 5 delivers the low-image-quality video content SD to the reception apparatus 1 in FIG. 3. More specifically, in response to the delivery request, the control unit 51 in the delivery apparatus 5 issues an instruction to the image-quality converting unit 52 so as to generate low-image-quality video content SD from the high-image-quality video content HD.

In response to the instruction, the image-quality converting unit 52 reads the high-image-quality video content HD from the storage 502 and newly generates low-image-quality video content SD having a reduced image quality. Upon completing the generation of the low-image-quality video content SD, the image-quality converting unit 52 outputs the generated low-image-quality video content SD to the encoding unit 54. The encoding unit 54 encodes the low-image-quality video content SD, input from the image-quality converting unit 52, for each predetermined data unit, and outputs the encoded low-image-quality video content SD to the input/output-data processing unit 53.

The input/output-data processing unit 53 packetizes the data input from the encoding unit 54 and transmits the packetized data to the Internet 4 (see FIG. 1) via the network interface 505. The video data and the audio data contained in the packet are delivered to the reception apparatus 1 through the Internet 4, the core network 3, and the base station 2.

In step S64, the storage control unit 14 in the reception apparatus 1 in FIG. 3 controls processing for storing, in the storage 102, the low-image-quality video content SD received by the wireless communication unit 105. More specifically, the wireless communication unit 105 in the reception apparatus 1 in FIG. 2 receives transmission signals including the video data and audio data of the low-image-quality video content SD transmitted from the base station 2, demodulates and decodes the received signals to generate decoded data, and outputs the decoded data to the input/output-data processing unit 15.

The storage control unit 14 issues an instruction to the input/output-data processing unit 15 so as to store the input data in the storage 102. In response to the instruction, the input/output-data processing unit 15 stores the input data in the storage 102 as raw data. Upon completing the storage of all of the data of the low-image-quality video content SD, the storage control unit 14 finishes the storage processing.

Thereafter, during the sequential playback of the high-image-quality video content HD, when it is determined that the sequential playback of the high-image-quality video content HD is not continuable, the content-switching control unit 12 switches the playback video content from the high-image-quality video content HD to the low-image-quality video content SD stored in the storage 102.

The reception apparatus 1 may also be adapted so that the resolution or the bit rate of low-image-quality video content SD having the same contents as those of the high-image-quality video content HD that has been sequentially played back can be designated, when the delivery request is issued in step S62. The designation makes it possible to store video content that meets the user's preference.

For example, in step S62, by operating the touch panel or the like of the reception apparatus 1, the user designates the resolution or the bit rate of low-image-quality video content SD having the same contents as those of the high-image-quality video content HD that has been sequentially played back. The request unit 13 in the reception apparatus 1 transmits the designated resolution and bit rate of the designated low-image-quality video content SD to the delivery apparatus 5 in FIG. 5.

In step S63, the control unit 51 in the delivery apparatus 5 issues an instruction to the image-quality converting unit 52 so as to generate low-image-quality video content SD at the designated resolution and bit rate. In response to the instruction, the image-quality converting unit 52 generates low-image-quality video content SD having the designated resolution and bit rate from the high-image-quality video content HD. Since the subsequent processes are substantially the same as those in step S63 described above, descriptions thereof are not given hereinafter.

(Second Storage Processing for Low-Image-Quality Video Content SD)

In the first storage processing for low-image-quality video content SD, the reception and the storage of low-image-quality video content SD are executed in parallel with the sequential playback of high-image-quality video content HD. That is, the high-image-quality video content HD and the low-image-quality video content SD are simultaneously delivered and received. When the high-image-quality video content HD and the low-image-quality video content SD are simultaneously delivered, as described above, the communication band of the wired communication path and/or the wireless communication path between the reception apparatus 1 and the delivery apparatus 5 is squeezed, and the communication efficiency decreases.

In addition, for example, because of the delivery standard of video content or from the standpoint of copyright protection of video content, there are cases in which the reception (or delivery) of two pieces of video content having the same contents is not permitted even if the image qualities thereof are different from each other.

Accordingly, after stopping the reception and the sequential playback of the high-image-quality video content HD, the reception apparatus 1 executes a scheme (second storage processing) for receiving the low-image-quality video content SD from the delivery apparatus 5 and storing the low-image-quality video content SD in the reception apparatus 1.

More specifically, the determining unit 11 makes a first determination as to whether or not the sequential playback of the high-image-quality video content HD is continuable and a second determination as to whether or not the low-image-quality video content SD is receivable. When it is determined that the sequential playback of the high-image-quality video content HD is not continuable and it is determined that the low-image-quality video content SD is receivable, the request unit 13 issues a request to the delivery apparatus 5 so as to deliver the low-image-quality video content SD. The storage control unit 14 stores, in the storage 102, the low-image-quality video content SD that the delivery apparatus 5 delivered in response to the request.

The determining unit 11 makes a determination (the second determination) as to whether or not the low-image-quality video content SD is receivable (hereinafter referred to as “video is receivable”, as appropriate), by using one of the following six determination schemes. The determination (the first determination) as to whether or not the sequential playback of the high-image-quality video content HD is continuable has been described above with reference to FIG. 3.

A first determination scheme is a scheme for determining whether or not the frame rate of video frames played back by the playback unit 17 is lower than a pre-defined second reference frame rate. When the frame rate determined by the playback unit 17 is higher than or equal to the second reference frame rate, the determining unit 11 determines that the video is receivable. The second reference frame rate is a rate pre-defined by the developer of the reception apparatus 1 through an experiment or the like. The second reference frame rate is lower than the first reference frame rate described above with reference to FIG. 3.

A second determination scheme is a scheme for determining whether or not a wireless error rate in wireless communication is higher than or equal to a pre-defined third reference wireless error rate. When the wireless error rate determined by the input/output-data processing unit 15 is lower than the third reference wireless error rate, the determining unit 11 determines that video is receivable. The third reference wireless error rate is a wireless error rate pre-defined by the developer of the reception apparatus 1 through an experiment or the like. The third reference wireless error rate is higher than the first reference wireless error rate described above with reference to FIG. 3.

A third determination scheme is a scheme for determining whether or not a reference amount of video data is receivable within a first reference time. The input/output-data processing unit 15 determines an amount of data of video data of video content received by the wireless communication unit 105 within the first reference time, and outputs the amount of data to the determining unit 11. When the amount of data determined by the input/output-data processing unit 15 is larger than or equal to the reference amount of video data, the determining unit 11 determines that the video is receivable. The reference amount of video data and the first reference time are pre-defined by the developer of the reception apparatus 1 through an experiment or the like.

A fourth determination scheme is a scheme for determining whether or not the radio-wave strength in wireless communication with the base station 2, the radio-wave strength being measured by the wireless communication unit 105, is lower than a third reference radio-wave strength. When the radio-wave strength measured by the wireless communication unit 105 is higher than or equal to the third reference radio-wave strength, the determining unit 11 determines that the video is receivable. The third reference radio-wave strength is lower than the first reference radio-wave strength described above with reference to FIG. 3. The third reference radio-wave strength is a radio-wave strength pre-defined by the developer of the reception apparatus 1 through an experiment or the like.

A fifth determination scheme is a scheme for determining whether or not the loss rate of communication packets contained in transmission signals transmitted from the base station 2 to the reception apparatus 1 in wireless communication between the base station 2 and the reception apparatus 1 is higher than or equal to a third reference loss rate. When the loss rate determined by the wireless communication unit 105 or the input/output-data processing unit 15 is lower than the third reference loss rate, the determining unit 11 determines that the video is receivable. The third reference loss rate is higher than the first reference loss rate described above with reference to FIG. 3. The third reference loss rate is a loss rate pre-defined by the developer of the reception apparatus 1 through an experiment or the like.

A sixth determination scheme is a scheme for determining whether or not the elapsed time from when the control unit 10 issues an “HTTP GET” request to the delivery apparatus 5 until the control unit 10 receives, from the delivery apparatus 5, a response to the request exceeds a third time. When the elapsed time is smaller than or equal to the third time, the determining unit 11 determines that the video is receivable. The third time is large than the first time described above with reference to FIG. 3. The third time is pre-defined by the developer of the reception apparatus 1 through an experiment or the like.

FIG. 13 is a sequence diagram illustrating an example of the second storage processing for low-image-quality video content SD.

In step S71, the reception apparatus 1 in FIG. 3 executes a process that is substantially the same as the process described in step S61 in FIG. 12. That is, the reception apparatus 1 executes the registration of the reception apparatus 1 (step S1 in FIG. 6) and the connection establishment (step S3 in FIG. 6) to the sequential playback of high-image-quality video content HD (step S10 in FIG. 6), without obtaining the low-image-quality video content SD from the delivery apparatus 5, which is described above in step S2 in FIG. 6.

During the sequential playback of the high-image-quality video content HD, the quality of wireless communication with the base station 2 decreases (see reference character A3 in FIG. 1).

In step S72, the determining unit 11 in FIG. 3 determines that the sequential playback of the high-image-quality video content HD is not continuable because of the decreased wireless quality, but the low-image-quality video content SD is receivable.

In step S73, the control unit 10 stores, in the storage 102, information regarding the video content and including the playback position of the high-image-quality video content HD that has been sequentially played back at the timing when the determining unit 11 determines that the sequential playback of the high-image-quality video content HD is not continuable.

Thereafter, in step S74, the request unit 13 issues a request to the control unit 51 in the delivery apparatus 5 in FIG. 5 so as to deliver, to the reception apparatus 1, the low-image-quality video content SD having the same contents as those of the high-image-quality video content HD that has been sequentially played back. In step S75, in response to the delivery request, the control unit 51 in the delivery apparatus 5 in FIG. 5 delivers the low-image-quality video content SD to the reception apparatus 1 in FIG. 3. Before delivering the low-image-quality video content SD, the control unit 51 in the delivery apparatus 5 stops the delivery of the high-image-quality video content HD. In step S76, the storage control unit 14 stores, in the storage 102, the low-image-quality video content SD received by the wireless communication unit 105. Since the processes in steps S74 to S76 are the same as or similar to those in the processes in steps S62 to S64 in FIG. 12, descriptions thereof are not given hereinafter.

When the storage of the low-image-quality video content SD is completed (that is, when step S76″ is completed), the content-switching control unit 12 switches the playback video content from the high-image-quality video content HD to the low-image-quality video content SD. That is, the content-switching control unit 12 executes switching processing for the video content.

Even when the storage of all of the data of the low-image-quality video content SD is not completed, the content-switching control unit 12 may execute the switching processing for the video content, at the time when the storage of a predetermined amount of data of the low-image-quality video content SD is completed. After the storage of part of the low-image-quality video content SD is completed, the switching processing for the video content may be executed. In such a case, compared with a case in which the switching processing for the video content is executed after the storage of all of the data of the low-image-quality video content SD is completed, the low-image-quality video content SD can be playback earlier. That is, the latency until video is played back is reduced.

In addition, the content-switching control unit 12 may also execute the switching processing for the video content, upon start of storage of the low-image-quality video content SD. That is, the content-switching control unit 12 may execute the sequential playback of the low-image-quality video content SD. When the sequential playback of the low-image-quality video content SD is executed in such a manner, the low-image-quality video content SD is played back earlier, compared with a case in which the switching processing for the video content is executed after the storage of part of the low-image-quality video content SD is completed.

(Flow of Second Storage Processing for Low-Image-Quality Video Content SD)

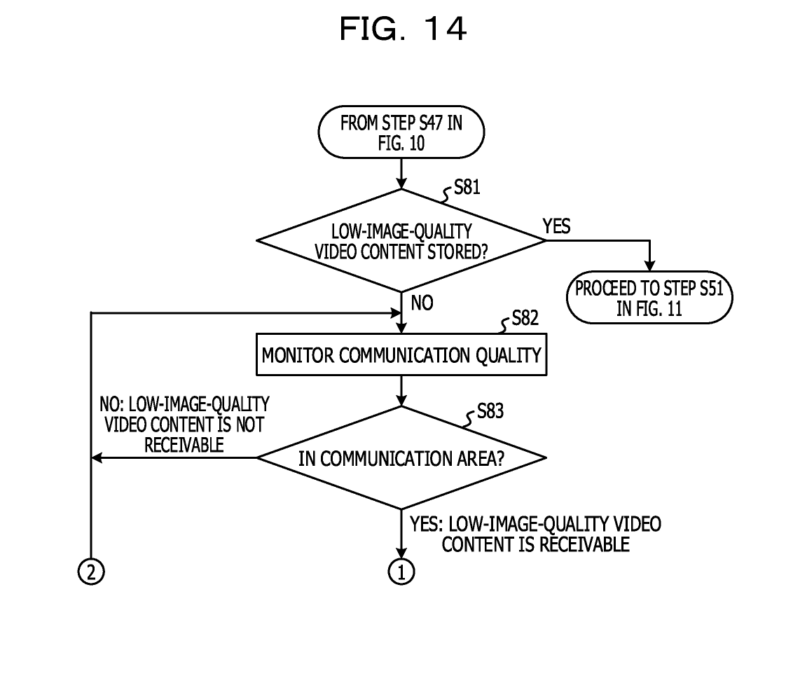

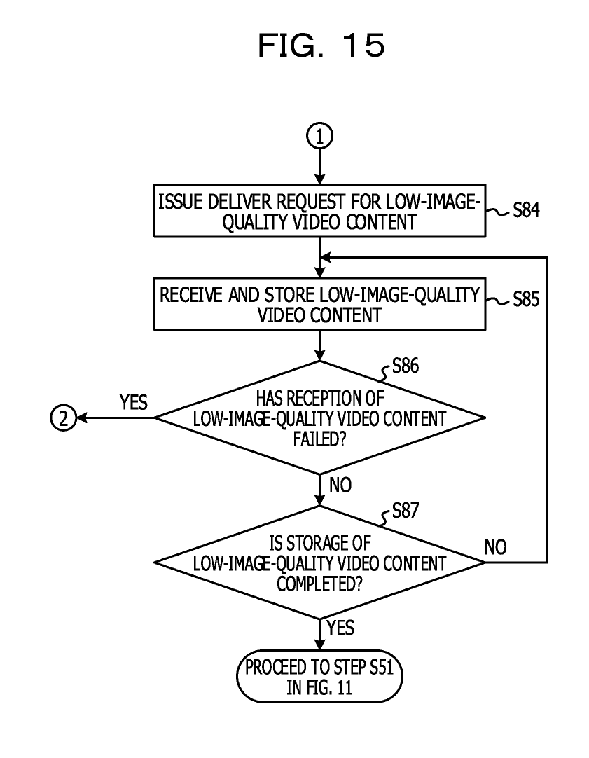

FIGS. 14 and 15 are first and second flowcharts illustrating a flow of the second storage processing for low-image-quality video content SD. Before processing described with reference to FIG. 14 is executed, the sequential playback of the high-image-quality video content HD is stopped (see step S47 in FIG. 10).

In step S81, the control unit 10 in the reception apparatus 1 in FIG. 3 determines whether or not low-image-quality video content SD having the same contents as those of the high-image-quality video content HD is stored in the storage 102. If low-image-quality video content SD having the same contents as those of the high-image-quality video content HD is stored in the storage 102 (YES in step S81), the process proceeds to step S51 in FIG. 11, and the reception apparatus 1 executes the switching processing for the video content.

If low-image-quality video content SD having the same contents as those of the high-image-quality video content HD is not stored in the storage 102 (NO in step S81), the process proceeds to step S82 in which the reception apparatus 1 receives low-image-quality video content SD from the delivery apparatus 5 and stores the received low-image-quality video content SD.

In step S82, the control unit 10 in the reception apparatus 1 monitors the communication quality of the wireless communication.

In step S83, the determining unit 11 determines whether or not the reception apparatus 1 is located in the communication area of the base station 2. The process in step S83 is substantially the same as the above-described process in step S42 in FIG. 10. If the reception apparatus 1 is not located in the communication area of the base station 2 (NO in step S83), the process returns to step S82. If the reception apparatus 1 is located in the communication area of the base station 2 (YES in step S83), the process proceeds to step S84 in FIG. 15. The case in which the reception apparatus 1 is located in the communication area of the base station 2 (YES in step S83) corresponds to a case in which the sequential playback of the high-image-quality video content HD is not possible but the low-image-quality video content SD is receivable.

In step S84 in FIG. 15, the request unit 13 in the reception apparatus 1 in FIG. 3 issues a request to the control unit 51 in the delivery apparatus 5 in FIG. 5 so as to deliver, to the reception apparatus 1, the low-image-quality video content SD having the same contents as those of the high-image-quality video content HD that has been sequentially played back.

In step S85, the wireless communication unit 105 receives the low-image-quality video content SD, and the storage control unit 14 controls processing for storing, in the storage 102, the low-image-quality video content SD received by the wireless communication unit 105.

Since descriptions of steps S84 and S85 are substantially the same as those in steps S62 and S64 in FIG. 12, detailed descriptions are not given hereinafter.

In step S86, the control unit 10 determines whether or not the reception of the low-image-quality video content SD has failed. If the reception of the low-image-quality video content SD has failed (YES in step S86), the process returns to step S82 in FIG. 14. If the reception of the low-image-quality video content SD has not failed (NO in step S86), the process proceeds to step S87.

In step S87, the control unit 10 determines whether or not the storage of all of the data of the low-image-quality video content SD is completed. That is, the control unit 10 determines whether or not the reception and the storage of the low-image-quality video content SD are completed. If the storage of the low-image-quality video content SD is not completed (NO in step S87), the process returns to step S85. If the storage of the low-image-quality video content SD is completed (YES in step S87), the process proceeds to step S51 in FIG. 11, and the switching processing of the video content is executed.

As described above in the first embodiment, the amount of data of the low-image-quality video content SD is one-seventh to one-tenth of the amount of data of the high-image-quality video content HD. When the total viewing/listening time of the high-image-quality video content HD is assumed to be X minutes, the time taken to receive all of the high-image-quality video content HD from the delivery apparatus 5 is about X minutes. Accordingly, the time taken to receive all of the low-image-quality video content SD from the delivery apparatus 5 is X/10 minutes at the shortest. Thus, since the time until the low-image-quality video content SD is received and stored can be reduced, the latency until video is played back is reduced.

The reception apparatus 1 may also store the low-image-quality video content SD in the external storage medium 6 connected via the external connection interface 104, rather than storing the low-image-quality video content SD in the storage 102 in the manner described in the first and second embodiments.

[Application Example of Reception Apparatus]

An apparatus that receives and plays back video content to be distributed, that complies with design guidelines called DLNA guidelines, and that complies with the DTCP+ standard developed by the DTLA may also execute the video-content switching processing described above in the first and second embodiments. When an apparatus complies with the DTCP+ standard, the second storage processing of the two types of storage processing (described above in the second embodiment) for low-image-quality video content SD is used from the viewpoint of copyright protection of video content. As described above, the second storage processing is a scheme (see FIG. 13) in which, after stopping sequential playback of high-image-quality video content HD, the reception apparatus 1 receives low-image-quality video content SD from the delivery apparatus 5 and stores the low-image-quality video content SD in the reception apparatus 1. The delivery apparatus for the video content is also an apparatus that complies with the DLNA guidelines and also the DTCP+ standard.

DLNA is an acronyms of the Digital Living Network Alliance. DTLA is an acronyms of the Digital Transmission Licensing Administrator. DTCP is an acronyms of Digital Transmission Content Protection.

The DLNA guidelines define a delivery apparatus that delivers recorded video content through a local network, such as a home network, and a playback apparatus (reception apparatus) that receives the video content delivered through the local network and plays back the video content. Upon receiving a video-content obtain request from the playback apparatus, the delivery apparatus reads video and audio data of video content, and performs, on the read data, encryption processing according to a predetermined copyright protection.

The delivery apparatus then stores the encrypted data in a buffer. When the amount of the stored data reaches a predetermined amount of data, the delivery apparatus delivers the data to the playback apparatus through the local network. The playback apparatus receives the delivered data and decodes the data to play back the video content.

The DTCP+ standard is a new version of the Digital Transmission Content Protection over Internet Protocol (DTCP-IP) standard. The DTCP-IP standard is a copyright protection system for inhibiting copying when video content to which a copyright protection technology for terrestrial digital broadcast or the like is applied is delivered through a local network, such as a home network. The DTCP+ standard is a copyright protection system for inhibiting copying when video content to which a copyright protection technology is applied is delivered not only in a local network but also in a wide area network, such as the Internet. As a result of the establishment of the DTCP+ standard, access to delivery apparatuses has been made possible through the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A reception apparatus comprising:
a wireless communication circuit configured to receive video content through wireless communication;
a memory; and
a processor coupled to the memory, configured to
play back the video content,
make a first determination as to whether or not sequential playback of first video content having a first image quality, the sequential playback being performed in parallel with reception of the first video content, is continuable, and
control, when the processor determines in the first determination that the sequential playback of the first video content is not continuable during sequentially playing back the first video content, switching processing for switching the video content to be played back from the received first video content to second video content stored in the memory, the second video content having a second image quality lower than the first image quality and having the same contents as contents of the first video content.

2. The reception apparatus according to claim 1,
wherein, after the processor starts the sequential playback of the first video content, the processor issues a request to a delivery apparatus that delivers the first video content to deliver the second video content, and stores, in the memory, the second video content that the delivery apparatus delivers in response to the request.

3. The reception apparatus according to claim 1,
wherein the processor makes a second determination as to whether or not the second video content is receivable, and
when the processor determines in the first determination that the sequential playback of the first video content is not continuable and the processor determines in the second determination that the second video content is receivable, the processor issues a request to a delivery apparatus that delivers the first video content to deliver the second video content and stores, in the memory, the second video content that the delivery apparatus delivers in response to the request.

4. The reception apparatus according to claim 3,
wherein, after completing the storage of the second video content, the processor executes the switching processing.

5. The reception apparatus according to claim 3,
wherein, upon starting the storage of the second video content, the processor executes the switching processing.

6. The reception apparatus according to claim 1,
wherein the processor makes a third determination as to whether or not sequential playback of video portion of the first video content is continuable and a fourth determination as to whether or not sequential playback of audio portion of the first video content is continuable, and
when the processor determines in the third determination that the sequential playback of the video portion of the first video content is not continuable and the processor determines in the fourth determination that the sequential playback of the audio portion of the first video content is continuable, the processor executes the switching processing for switching video portion of the video content to be played back by the processor from the video portion of the first video content to video portion of the second video content and makes the processor continue the sequential playback of the audio portion of the first video content.

7. The reception apparatus according to claim 1,
wherein a case in which the sequential playback of the first video content is not continuable corresponds to a case in which a frame rate of video frames played back by the processor is lower than a pre-defined reference frame rate.

8. The reception apparatus according to claim 1,
wherein a case in which the sequential playback of the first video content is not continuable corresponds to a case in which a wireless error rate in the wireless communication is higher than or equal to a pre-defined reference wireless error rate.

9. The reception apparatus according to claim 1,
wherein a case in which the sequential playback of the first video content is not continuable corresponds to a case in which a pre-defined amount of video data used for the sequential playback is not received within a reference time.

10. The reception apparatus according to claim 1,
wherein a case in which the sequential playback of the first video content is not continuable corresponds to a case in which a loss rate of communication packets contained in transmission signals in the wireless communication is higher than or equal to a pre-defined reference loss rate.

11. The reception apparatus according to claim 1,
wherein the processor stores, in the memory, a playback position of the first video content at a timing when the processor determines that the sequential playback of the first video content is not continuable; and
the processor starts playback of the second video content from the playback position stored in the memory.

12. The reception apparatus according to claim 6,
wherein the processor starts playback of the video portion of the second video content in synchronization with a playback position at which the sequential playback of the audio portion of the first video content is performed.

13. The reception apparatus according to claim 1,
wherein, when the processor determines that the sequential playback of the first video content is continuable during playback of the second video content, the processor switches the video content to be played back by the processor from the second video content to the first video content.

14. The reception apparatus according to claim 6,
wherein, when the processor determines that the sequential playback of the first video content is continuable during playback of the video portion of the second video content, the processor switches video portion of the video content to be played back by the processor from the video portion of the second video content to the video portion of the first video content.

15. A reception method executed by a reception apparatus that receives video content through wireless communication, the method comprising:
the reception apparatus
performing sequential playback of first video content having a first image quality in parallel with reception of the first video content;
determining, by a processor, whether or not the sequential playback of the first video content is continuable; and
switching, when the processor determines in the determination that the sequential playback of the first video content is not continuable during sequential playback of the first video content, the video content to be played back from the received first video content to second video content stored in a memory, the second video content having a second image quality lower than the first image quality and having the same contents as contents of the first video content.

16. A machine readable medium storing a program that, when executed by a processor, causes the processor to perform operations comprising:
performing sequential playback of first video content having a first image quality in parallel with reception of the first video content;
determining whether or not the sequential playback of the first video content is continuable; and
switching, when the processor determines in the determination that the sequential playback of the first video content is not continuable during sequential playback of the first video content, the video content to be played back from the received first video content to second video content stored in a memory, the second video content having a second image quality lower than the first image quality and having the same contents as contents of the first video content.
